(19) United States
(12) Patent Application Publication
(10) Pub. No.: US 2012/0239585 A1
(43) Pub. Date: Sep. 20, 2012

(54) SYSTEMS AND METHODS FOR FACILITATING RECRUITMENT

(76) Inventor: Mark Henry Harris Bailey, Thornhill (CA)

(21) Appl. No.: 13/051,539

(22) Filed: Mar. 18, 2011

(51) Int. Cl. G06Q 10/00

(52) U.S. Cl. 705/321

(57) ABSTRACT

A system and method for facilitating recruitment comprises a database and a processor. The database stores hiring company records, recruiter records, candidate records, and job orders. The processor is coupled to the database, and performs anti-fraud searches and transmits candidate submissions. The submissions are transmitted where the anti-fraud search finds that there has been no fraud, and the candidate submission corresponds to the recruiter submission, and an amount of recruiter submissions is less than or equal to an amount of hiring company specified submissions.

### TECHNICAL FIELD

The present invention relates to the recruitment of candidates to fill employment positions. In particular, the invention relates to an automated process running over public access Internet for facilitating recruitment between hiring companies, recruiters, and candidates.

### BACKGROUND

Recruitment can generally be described as the process of attracting, screening, and selecting qualified candidates for employment at a hiring company. Recruitment can be conducted by a variety of entities including professional employment agencies, recruitment firms, in-house human resource departments, and individuals.

Recruitment firms may build internal resume databases. Historically, the recruitment firms with the best internal resume databases have often been the most successful, as hiring companies value this asymmetric information. More recently, the process of recruiting has been conducted by using online resume databases.

Recruiters and hiring companies establish relationships through negotiated contracts, a matching of the recruiters industry of expertise to the hiring company's need, and the personal connections between the recruiter and hiring company.

In certain cases, an intermediary company will act as a conduit for organizing communications between many recruiters and one hiring company. However, the relationships between the intermediary company and the recruiters are the same as the relationship between the hiring company and a direct recruiter. There is no free access to information as the intermediary company controls information and opportunity.

### BRIEF DESCRIPTION OF THE DRAWINGS

For a better understanding of embodiments of the systems and methods described herein, and to show more clearly how they may be carried into effect, reference will be made, by way of example, to the accompanying drawings in which:

FIG. 1 is a block diagram of a recruitment network system in accordance with at least one embodiment;

FIG. 2A is a block diagram of the database of the recruitment computing system of FIG. 1 in accordance with at least one embodiment;

FIG. 2B is a flowchart of a method performed on the processor of the recruitment computing system of FIG. 1 in accordance with at least one embodiment;

FIG. 3 is a flowchart of a method for creating a hiring company record in accordance with at least one embodiment;

FIG. 4 is a flowchart of a method for creating a recruiter record in accordance with at least one embodiment;

FIG. 5 is a flowchart of a method for creating a candidate record in accordance with at least one embodiment;

FIG. 6A and FIG. 6B are flowcharts of a method for registering a candidate record in accordance with at least one embodiment;

FIG. 7 is a flowchart of a method for performing an anti-fraud search on a candidate record in accordance with at least one embodiment;

FIG. 8 is a flowchart of a method for editing a candidate record in accordance with at least one embodiment;

FIG. 9 and FIG. 10 are flowcharts of a method for creating a job order in accordance with at least one embodiment;

FIG. 11 is a flowchart of a method for conducting an anti-fraud search of a job order in accordance with at least one embodiment;

FIG. 12 is a flowchart of a method for conducting another anti-fraud search of a job order in accordance with at least one embodiment;

FIG. 13 is a flowchart of a method for editing a job order in accordance with at least one embodiment;

FIG. 14 is a flowchart of a method for conducting another anti-fraud search of a job order in accordance with at least one embodiment;

FIG. 15 is a flowchart of a method for creating job order notification settings in accordance with at least one embodiment;

FIG. 16 is a flowchart of a method for editing a relationship record in accordance with at least one embodiment;

FIG. 17 is a flowchart of a method for editing a relationship record in accordance with at least one embodiment;

FIG. 18 is a flowchart of a method for editing a relationship record in accordance with at least one embodiment;

FIG. 19 and FIG. 20 are flowcharts of a method for creating a recruiter submission in accordance with at least one embodiment;

FIG. 21 is a flowchart of a method for creating a candidate submission in accordance with at least one embodiment;

FIG. 22 is a flowchart of a method for creating an internal employee submission in accordance with at least one embodiment;

FIG. 23 is a flowchart of a method for activating a submission in accordance with at least one embodiment;

FIG. 24 is a flowchart of a method for advancing a submission in accordance with at least one embodiment;

FIG. 25 and FIG. 26 are flowcharts of a method for coordinating an interview in accordance with at least one embodiment;

FIG. 27 is a flowchart of a method for feedback in accordance with at least one embodiment;

FIG. 28 is a flowchart of a method for managing active email accounts in accordance with at least one embodiment;

FIG. 29 is a flowchart of a method for managing the offer process in accordance with at least one embodiment;

FIG. 30 is a flowchart of a method for managing the billing process in accordance with at least one embodiment; and

FIG. 31 is a flowchart of a method for managing conflict resolution in accordance with at least one embodiment.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

The embodiments described herein provide in one aspect, a system for facilitating recruitment, the system comprising:

a database for storing at least one hiring company record, at least one recruiter record, at least one candidate record, and at least one job order, wherein creation of a candidate record is initiated in a recruiter record, wherein a hiring company record comprises a job order and the job order conforms to a set of standard job order criteria, and wherein the hiring company record is controlled by a hiring company user, the recruiter record is controlled by a recruiter user, and the candidate record is controlled by a candidate user;

a processor coupled to the database, said processor operable to:
perform an anti-fraud search on the hiring company record, the recruiter record, the candidate record, and the job order, wherein a candidate submission is initiated in the recruiter record, wherein the candidate record comprises the candidate submission, and the recruiter record comprises a recruiter submission; and
transmit the candidate submission only where the anti-fraud search finds that there has been no fraud, and the candidate submission corresponds to the recruiter submission, and an amount of recruiter submissions is less than or equal to an amount of hiring company specified submissions.

The embodiments described herein provide in one aspect, a system for facilitating recruitment, the system further comprising wherein the anti-fraud search comprises comparing the hiring company record, the recruiter record, the candidate record, and the job order to an at least one corresponding prior hiring company record, recruiter record, candidate record, and job order.

The embodiments described herein provide in one aspect, a system for facilitating recruitment, the system further comprising wherein the processor is further operable to rank the candidate record, wherein the hiring company record provides input into a candidate record's ranking.

The embodiments described herein provide in one aspect, a system for facilitating recruitment, the system further comprising wherein the processor is further operable to create an interview schedule from data in the hiring company record and the candidate record and transmit the interview schedule.

The embodiments described herein provide in one aspect, a system for facilitating recruitment, the system further comprising wherein the processor is further operable to: create an offer in the candidate record, wherein the creation of the offer is initiated in the hiring company record, and wherein after the offer is created the offer is accepted, rejected, or a counter-offer is created.

The embodiments described herein provide in one aspect, a system for facilitating recruitment, the system further comprising wherein the processor is further operable to facilitate a feedback module.

The embodiments described herein provide in one aspect, a system for facilitating recruitment, the system further comprising wherein the processor is further operable to create an at least one relationship record between the hiring company record and the recruiter record.

The embodiments described herein provide in one aspect, a method for facilitating recruitment, the method comprising:

storing at least one hiring company record, at least one recruiter record, at least one candidate record, and at least one job order in a database, wherein creation of a candidate record is initiated by a recruiter record, wherein a hiring company record comprises a job order and the job order conforms to a set of standard job order criteria, and wherein the hiring company record is controlled by a hiring company user, the recruiter record is controlled by a recruiter user, and the candidate record is controlled by a candidate user;

performing an anti-fraud search on the hiring company record, the recruiter record, the candidate record, and the job order, wherein a candidate submission is initiated in the recruiter record, wherein the candidate record comprises the candidate submission, and the recruiter record comprises a recruiter submission, and

transmitting the candidate submission only where the anti-fraud search finds that there has been no fraud, and the candidate submission corresponds to the recruiter submission, and an amount of recruiter submissions is less than or equal to an amount of hiring company specified submissions.

The embodiments described herein provide in one aspect, a non-transitory computer readable medium for performing a method for facilitating recruitment, the method comprising:

storing at least one hiring company record, at least one recruiter record, at least one candidate record, and at least one job order in a database, wherein creation of a candidate record is initiated by a recruiter record, wherein a hiring company record comprises a job order and the job order conforms to a set of standard job order criteria, and wherein the hiring company record is controlled by a hiring company user, the recruiter record is controlled by a recruiter user, and the candidate record is controlled by a candidate user;

performing an anti-fraud search on the hiring company record, the recruiter record, the candidate record, and the job order, wherein a candidate submission is initiated in the recruiter record, wherein the candidate record comprises the candidate submission, and the recruiter record comprises a recruiter submission, and

transmitting the candidate submission only where the anti-fraud search finds that there has been no fraud, and the candidate submission corresponds to the recruiter submission, and an amount of recruiter submissions is less than or equal to an amount of hiring company specified submissions.

The embodiments described herein provide in one aspect, a method for facilitating recruitment, the method further comprising wherein the anti-fraud search comprises comparing the hiring company record, the recruiter record, the candidate record, and the job order to an at least one corresponding prior hiring company record, recruiter record, candidate record, and job order.

The embodiments described herein provide in one aspect, a method for facilitating recruitment, the method further comprising ranking the candidate record, wherein the hiring company record provides input into a candidate record's ranking.

The embodiments described herein provide in one aspect, a method for facilitating recruitment, the method further comprising creating an interview schedule from data in the hiring company record and the candidate record and transmit the interview schedule.

The embodiments described herein provide in one aspect, a method for facilitating recruitment, the method further comprising creating an offer in the candidate record, wherein the creation of the offer is initiated in the hiring company record, and wherein after the offer is created the offer is accepted, rejected, or a counter-offer is created.

The embodiments described herein provide in one aspect, a method for facilitating recruitment, the method further comprising facilitating a feedback module.

The embodiments described herein provide in one aspect, a method for facilitating recruitment, the method further comprising creating an at least one relationship record between the hiring company record and the recruiter record.

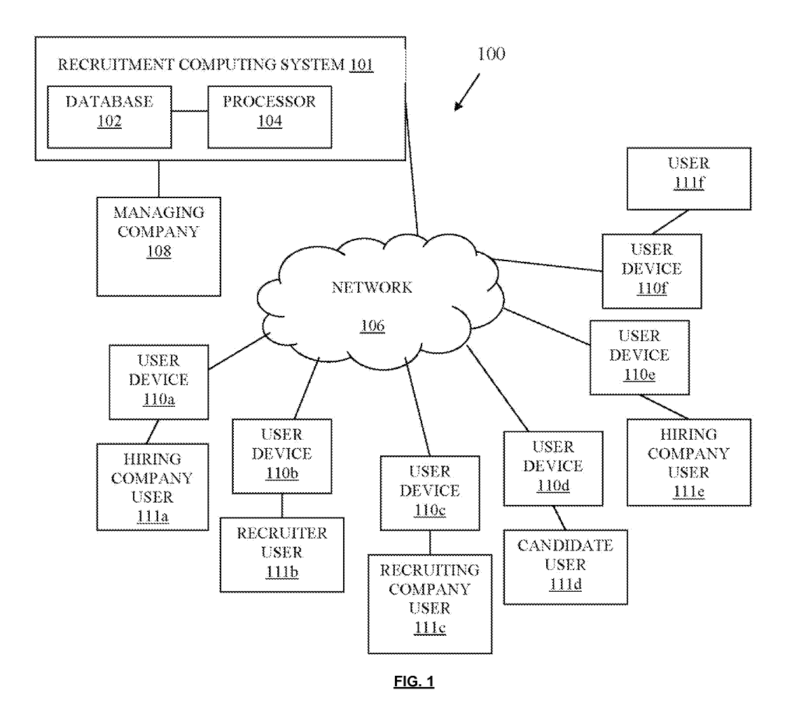

Reference is now made to FIG. 1, in which a recruitment network system 100 in accordance with an embodiment is illustrated. Recruitment network system 100 includes user devices 110 and users 111. User devices 110 are connected to a recruitment computing system 101 via a network 106. Recruitment computing system 101 comprises a database 102 and a processor 104. A managing company 108 manages aspects of the recruitment computing system 101.

In an embodiment, managing company 108 has access to and control of all data in database 102. In a further embodiment, managing company 108 can manage and alter records in database 102 including, for example, hiring company records, recruiter records, candidate records, and conflict records.

Recruitment computing system 101 may be implemented using, for example, a general-purpose computer capable of responding to and executing instructions in a defined manner, a personal computer, a special purpose computer, a workstation, a server, a device, a component, or other equipment or some combination thereof capable of responding to and executing instructions. While recruitment computing system 101 is described as comprising database 102 and processor 104 it will be understood by those skilled in the art that the recruitment computer system 101 may comprise any number of databases and processors to implement the system.

User device 110a may be operated by, for example, an individual at a hiring company user 111a. A hiring company user 111a may be a company with a current or potential employment position that it is looking to have filled by an acceptable candidate. An individual in charge of administering the hiring of a candidate may operate the hiring company user device 110a.

User device 110b may be operated by, for example, an individual recruiter user 111b. An individual recruiter user is an individual looking to recruit candidates to fill employment positions for a hiring company user 111a. In an embodiment, recruiter user 111b is an individual that introduces a job to a candidate. In an embodiment, recruiter user 111b is not qualified by system 101 or managing company 108 as to the recruiter user's abilities and skills as a recruiter.

User device 110c may be operated by, for example a recruiting company user 111c. The recruiting company user 111c may represent a multiple of recruiters and act as a conduit for an individual recruiter within the recruiting company.

User device 110d may be operated by, for example a candidate user 111d. Candidate user 111d is an individual looking for employment with hiring company user 111a. Recruiter user 111b recruits candidate user 111d for employment positions at hiring company user 111a.

User device 110e may be operated by, for example, an individual at a hiring company user similar to user 111a, where the difference is that user 111e operating user device 110e is looking to hire a candidate from within the hiring company. In this case, user 111e may acts as a recruiter user 111b and a hiring company user 111a.

User device 110f may be operated by, for example, another type of user 111f.

It will be appreciated that recruitment network system 100 is not limited to user devices 110a, 110b, 110c, 110d, 110e, and 110f and users 111a, 111b, 111c, 111d, 111e, and 111f. Recruitment network system 100 may comprise an unlimited number of user devices 110 operated by any number of various users 111. Further, it is contemplated that users 111 may access network 106 from a multiple and a variety of different devices 110 and need not use the same device 110 each time user 111 access recruitment computing system 101 via network 106.

Each user device 110 is preferably implemented by the use of one or more general purpose computers, such as, for example, a typical personal computer manufactured by Dell™, Gateway™, or Hewlett-Packard™. Those skilled in the art will understand that the user devices 110 may be a laptop computer, a personal digital assistant (PDA), a mobile phone, a set top box, an interactive television or the like.

The user devices 110 may include a microprocessor. The microprocessor can be any type of processor, such as, for example, any type of general-purpose microprocessor or microcontroller, a digital signal processing (DSP) processor, an application-specific integrated circuit (ASIC), a programmable read-only memory (PROM), or any combination thereof.

The user devices 110 can also include computer memory, such as, for example, random-access memory (RAM). However, the computer memory of user devices 110 can be any type of computer memory or any other type of electronic storage medium that is located either internally or externally to the user devices 110, such as, for example, read-only memory (ROM), compact disc read-only memory (CDROM), electro-optical memory, magneto-optical memory, erasable programmable read-only memory (EPROM), and electrically-erasable programmable read-only memory (EEPROM), or the like.

According to exemplary embodiments, the corresponding RAM can contain, for example, a web browser application for the user devices 110. The web browser application typically will communicate with the network 106 to allow a user 111 operating a user device 110 to access and participate in a recruitment system interface hosted by recruitment computing system 101.

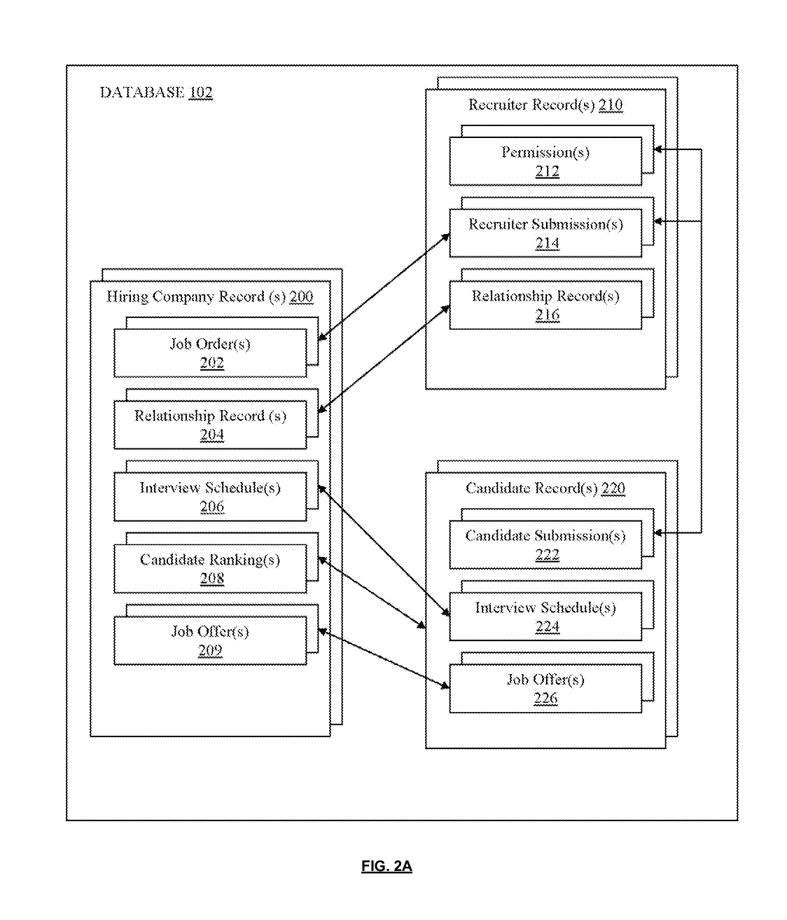

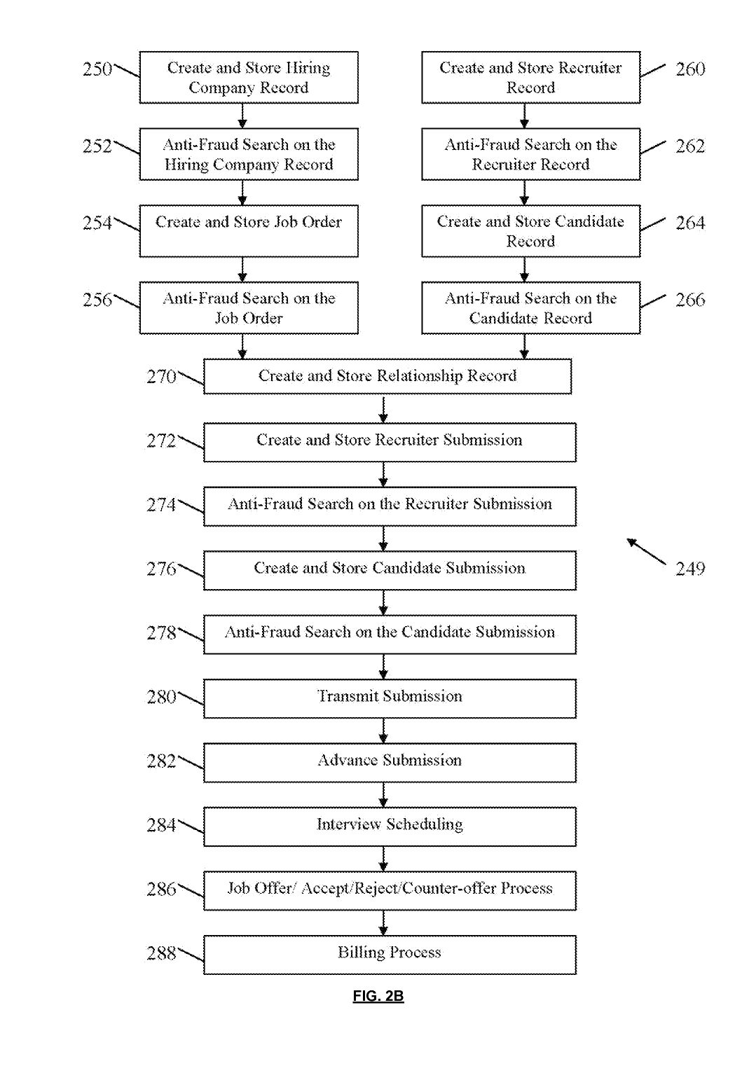

Recruitment computing system 101 hosts one or more recruitment system interfaces. Recruitment computing system 101 typically includes a web server to receive and respond to network requests made by the web browser of user device 110. An exemplary recruitment computing system 101 will be described in greater detail in reference to FIG. 2A and FIG. 2B.

The network 106 may be a local area network (LAN), a wide area network (WAN), the Internet, analog or digital wired and wireless telephone networks (e.g. a Public Switched Telephone Network (PSTN), an Integrated Services Digital Network (ISDN), or a Digital Subscriber Line (xDSL)), or any other wired or wireless network. The network 106 may include multiple networks or subnetworks, each of which may include, for example, a wired or wireless communications channel.

Reference is now made to FIG. 2A, in which an exemplary embodiment of database 102 of recruitment computing system 101 of FIG. 1 is illustrated. In the exemplary embodiment shown in FIG. 2A, database 102 stores at least one hiring company record 200, at least one candidate record 220, and at least one recruiter record 210.

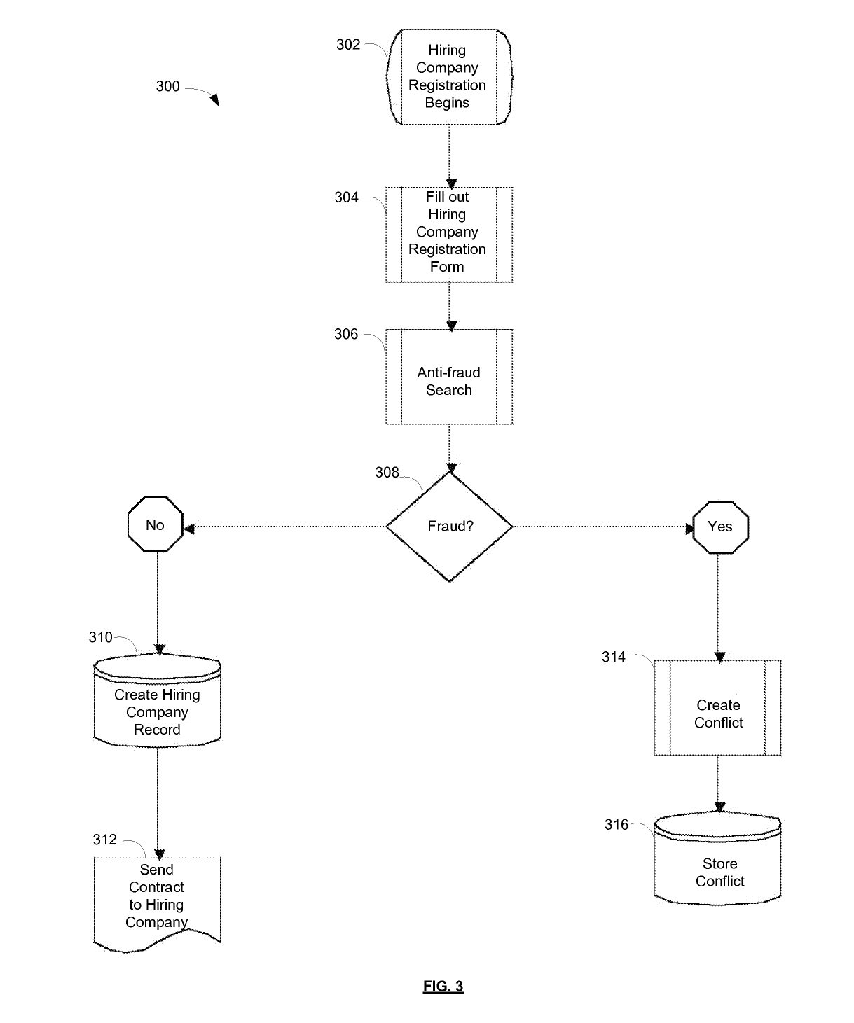

Hiring company record 200 represents the information relating to a user 111, for example, the hiring company user 111a, 111e of FIG. 1. Hiring company records 200 will be discussed in further detail having regard to FIG. 3.

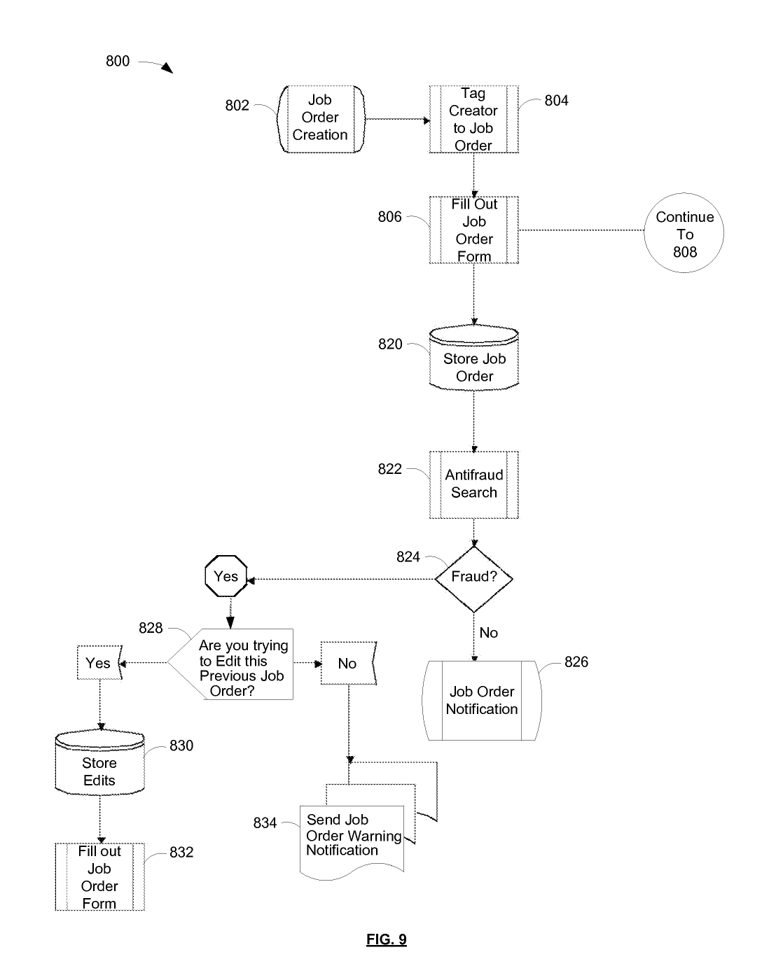

Hiring company record 200 may comprise at least one job order 202. Job order 202 may be created from input by a hiring company user 111a, 111e on a user device 110. Job order 202 pertains to information about an employment position available to be filled at the hiring company user 111a, 111e. Job orders 202 will be discussed in further detail having regard to FIGS. 9 to 15.

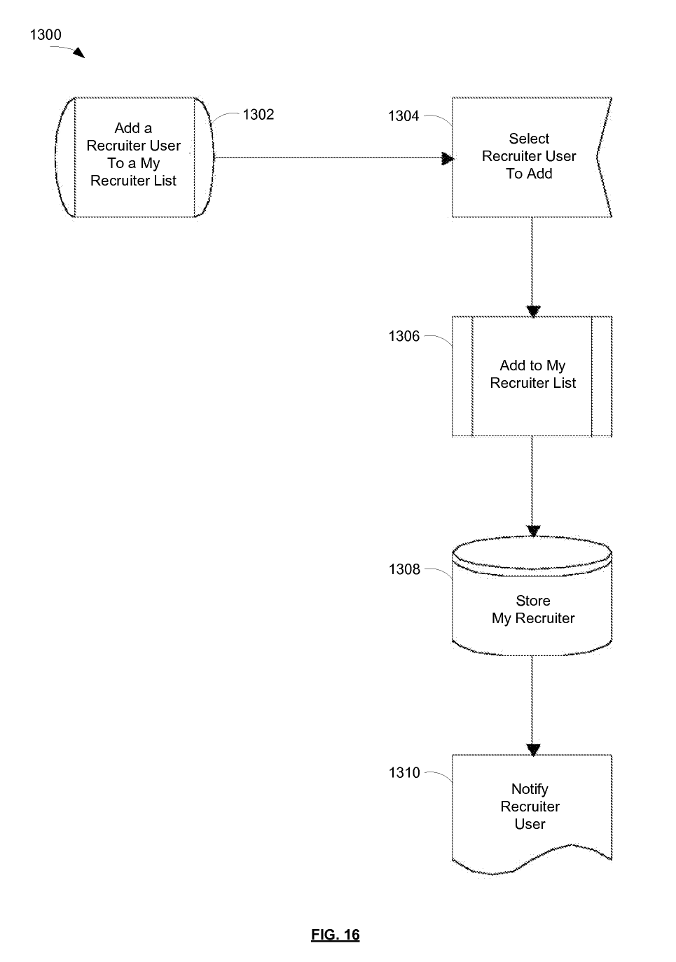

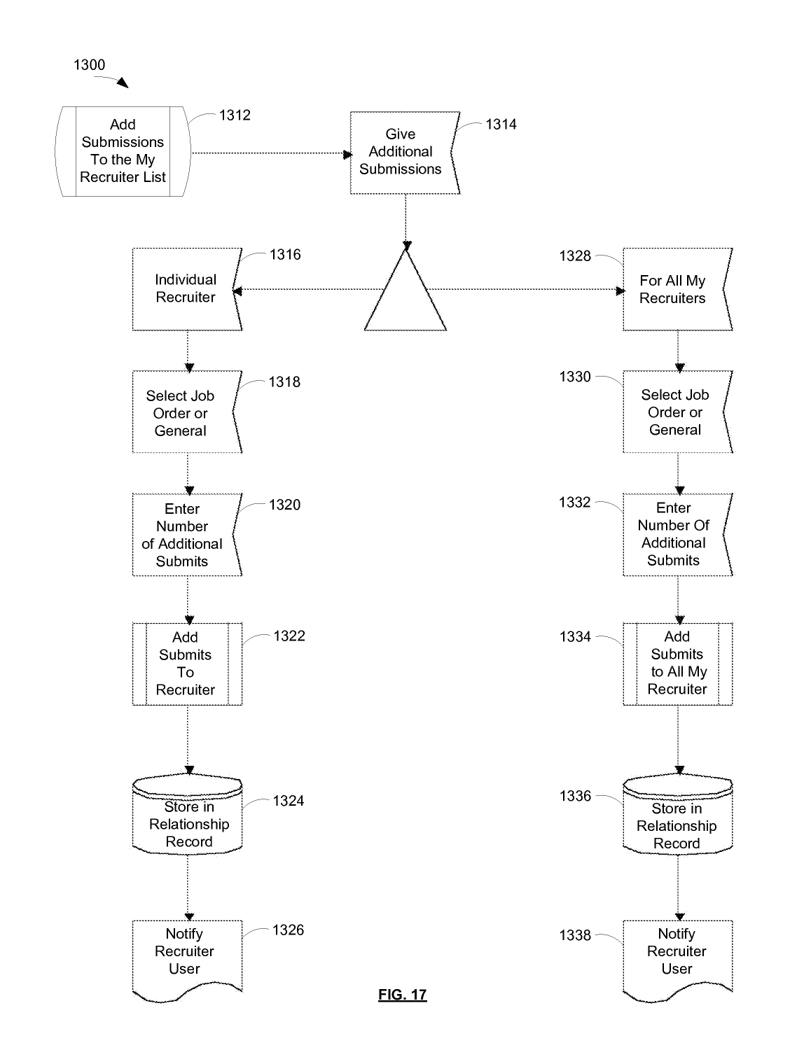

Hiring company record 200 may comprise at least one relationship record 204. Relationship record 204 may be created from input by a hiring company user 111a, 111e on a user device 110. Relationship record 204 pertains to information about the relationship between the hiring company user 111a and a recruiter user 111b, 111c. Relationship records 204 will be discussed in further detail having regard to FIGS. 16 to 18.

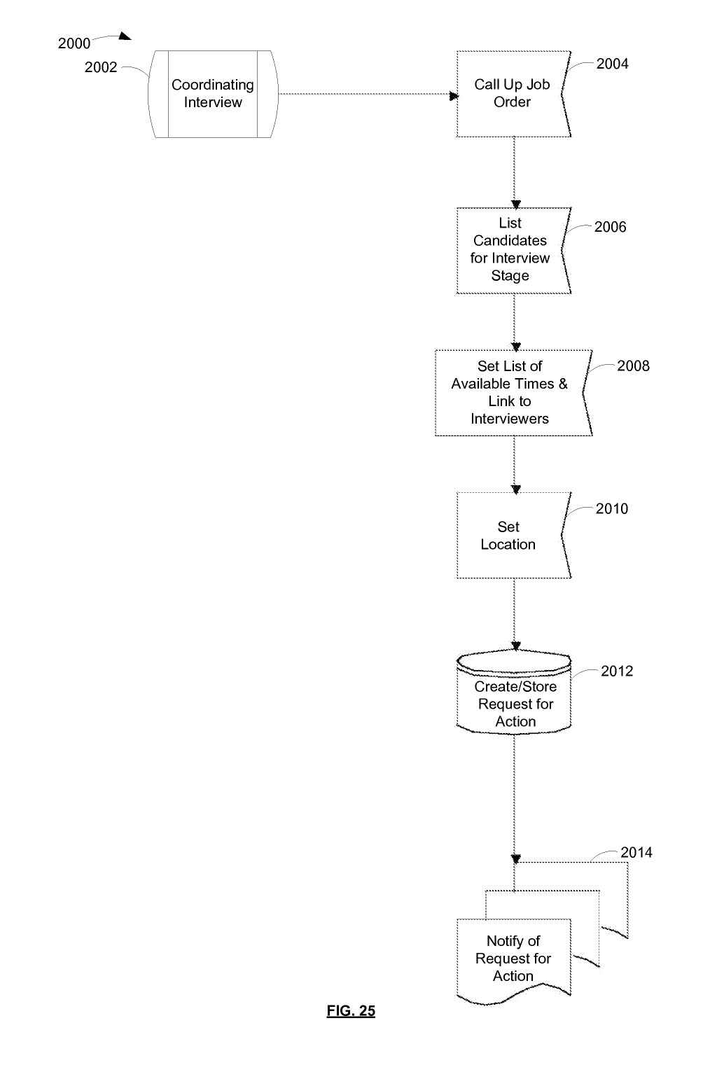

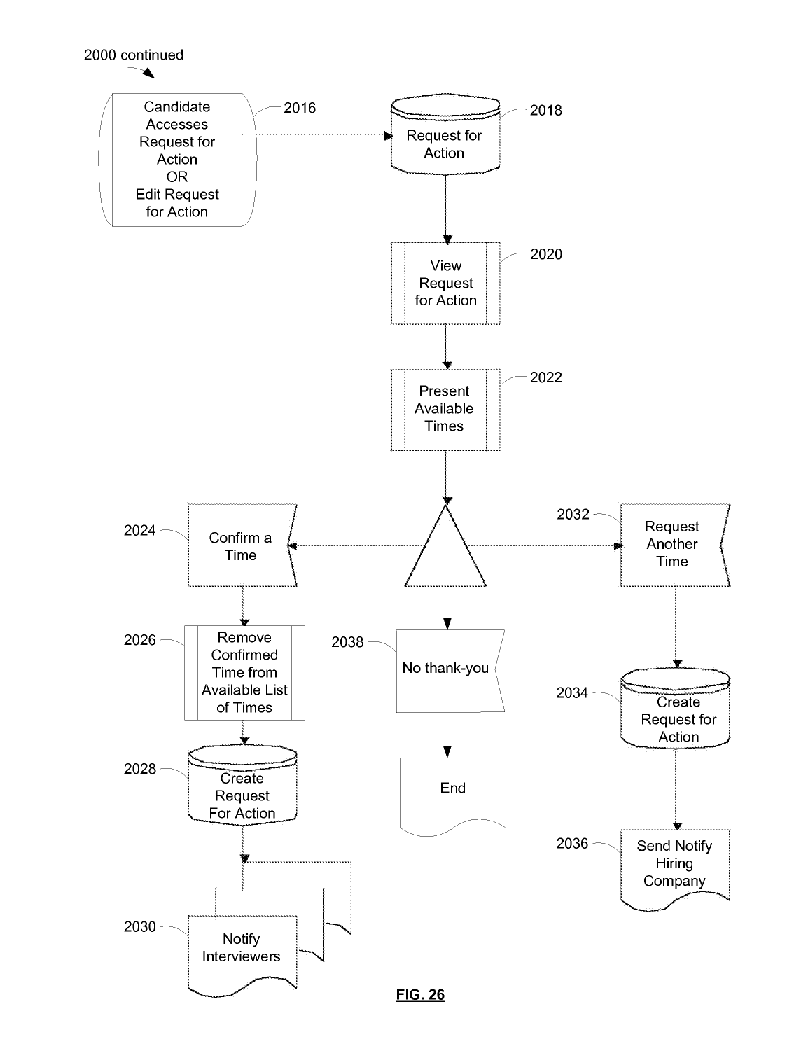

Hiring company record 200 may comprise at least one interview schedule 206. Interview schedule 206 may be created from input by a hiring company user 111a, 111e on a user device 110. Interview schedule 206 pertains to information about the interviewing of at least one candidate user 111d by hiring company user 111a, 111e. Interview schedules 206 will be discussed in further detail having regard to FIGS. 25 and 26.

Hiring company record 200 may comprise at least one candidate ranking 208. Candidate ranking 208 may be created from input by a hiring company user 111a, 111e on a user device 110. Candidate ranking 208 pertains to information about the ranking of at least one candidate user 111d by hiring company user 111a, 111e

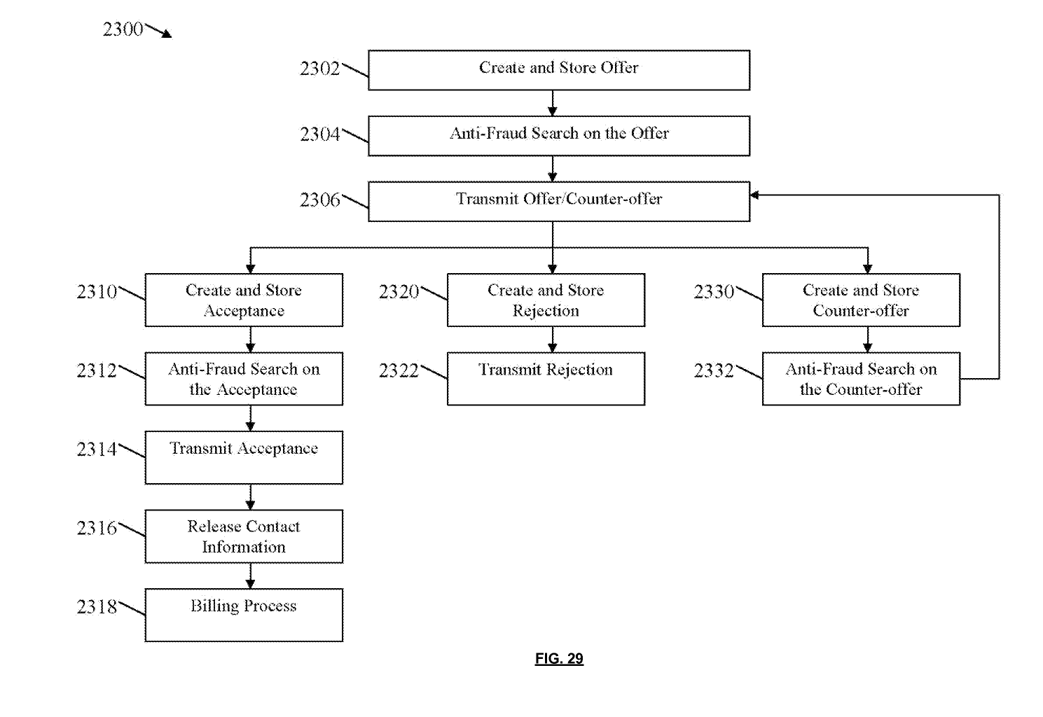

Hiring company record 200 may comprise at least one job offer 209. Job offer 209 may be created from input by a hiring company user 111a, 111e on a user device 110. Job offer 209 pertains to information about a job offer made to at least one candidate user 111d by hiring company user 111a, 111e. Job offers 209 will be discussed in further detail having regard to FIG. 29.

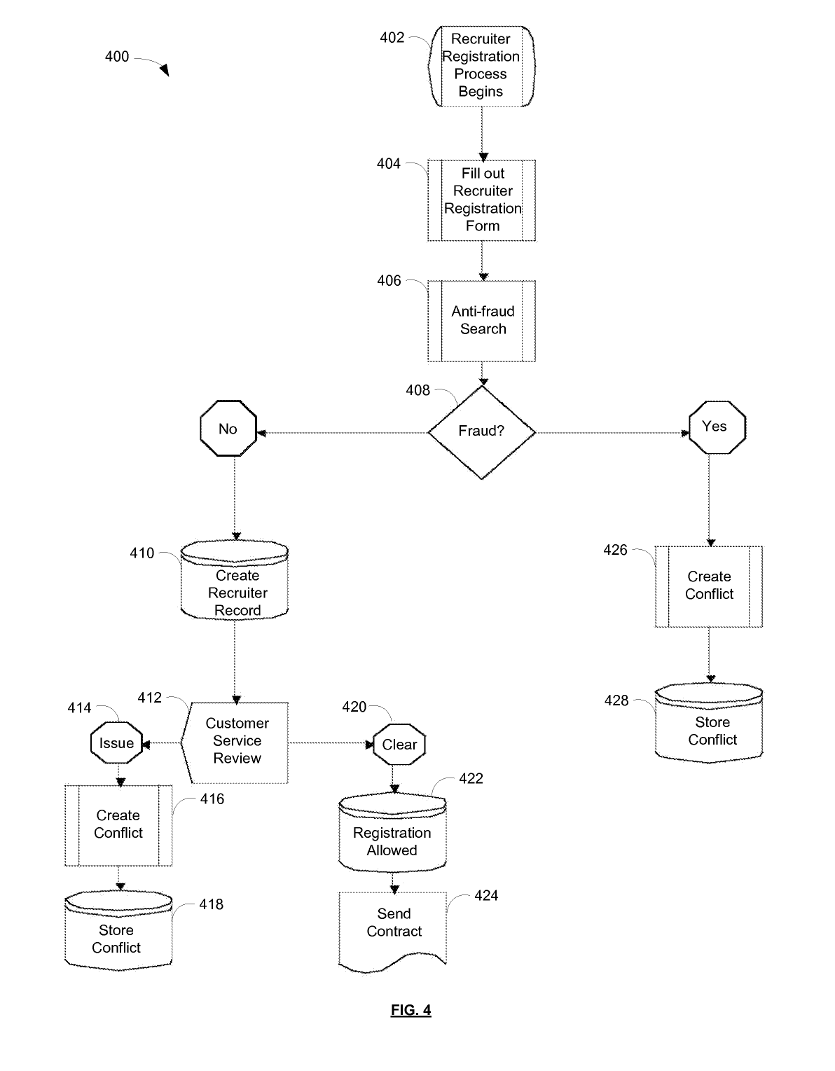

Database 102 of recruitment computing system 101 comprises at least one recruiter record 210. Recruiter records 210 will be discussed in further detail having regard to FIG. 4.

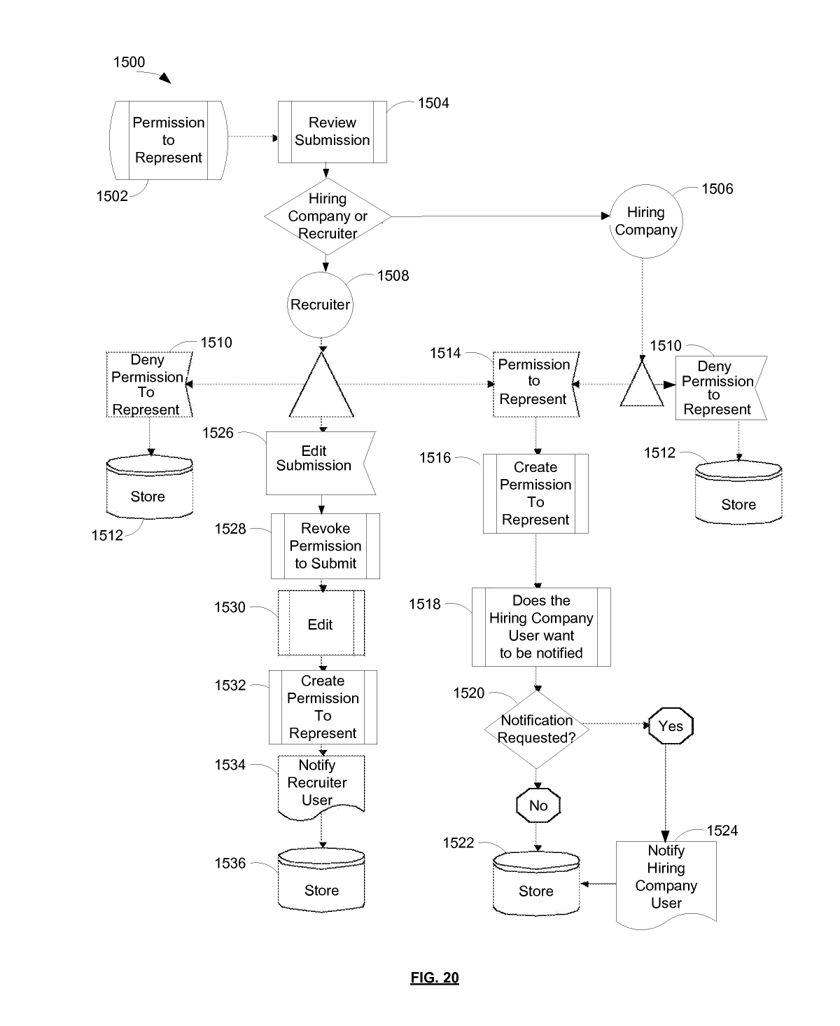

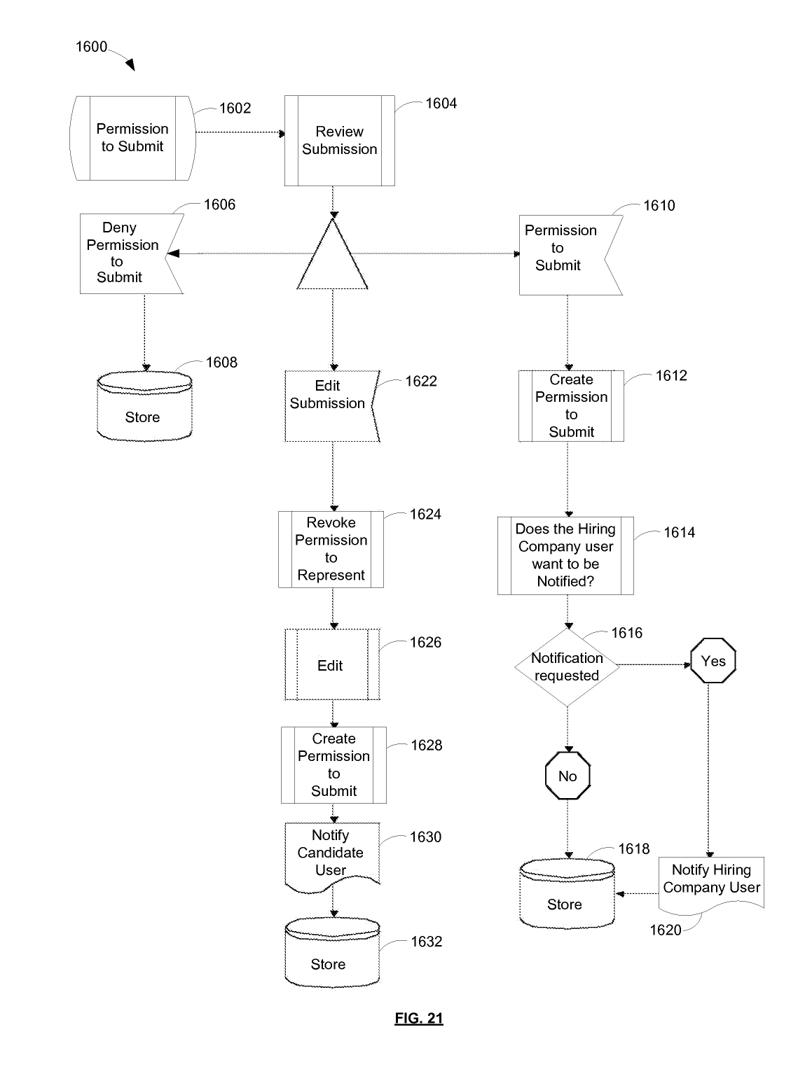

Recruiter record 210 may comprise at least one permission to represent 212. Permission to represent 212 may be created from input by a recruiter user 111b, 111c on a user device 110. Permission to represent 212 pertains to at least one candidate user 111d granting permission of the recruiter user 111b, 111c to work with the candidate user 111d in the recruitment process. Permission to represent 212 will be discussed in further detail having regard to FIGS. 20 and 21.

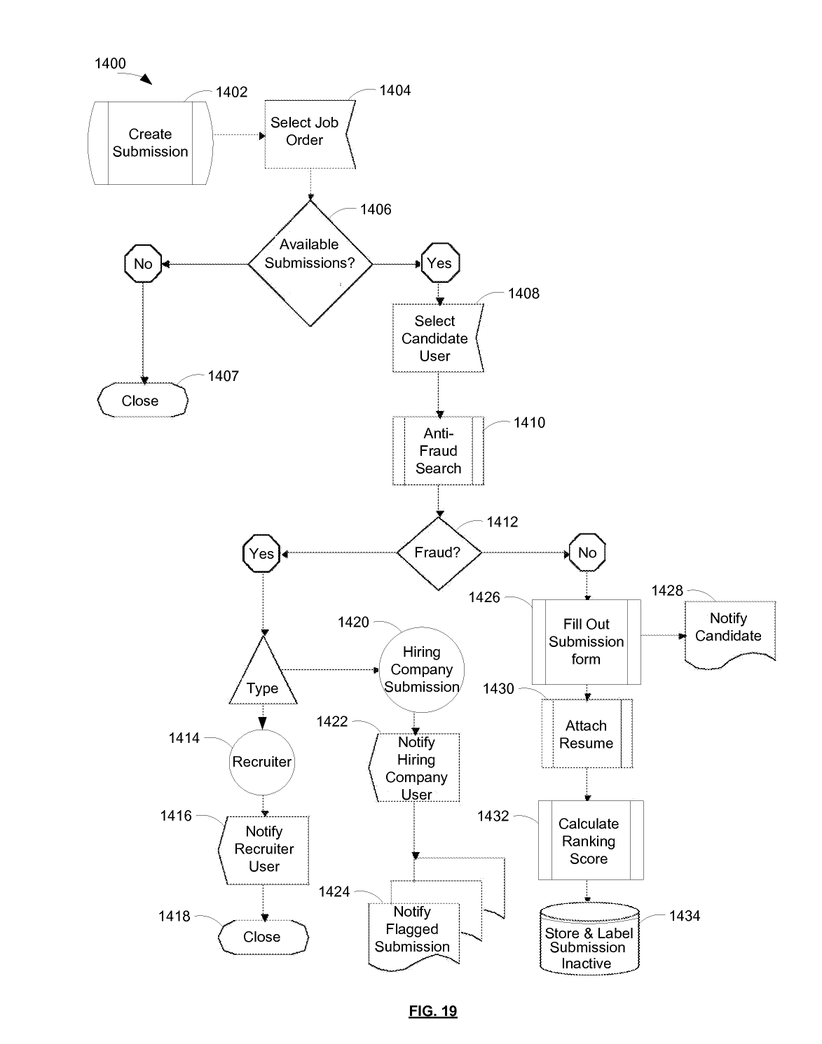

Recruiter record 210 may comprise at least one recruiter submission 214. Recruiter submission 214 may be created from input by a recruiter user 111b, 111c on a user device 110. Recruiter submission 214 pertains to an application on a job order 202. Recruiter submissions 214 will be discussed in further detail having regard to FIGS. 19 and 20.

Recruiter record 210 may comprise at least one relationship record 216. Relationship record 216 may be created from input by a recruiter user 111b, 111c on a user device 110. Relationship record 216 pertains to information about the relationship between the hiring company user 111a and a recruiter user 111b, 111c. Relationship records 216 will be discussed in further detail having regard to FIGS. 16 to 18.

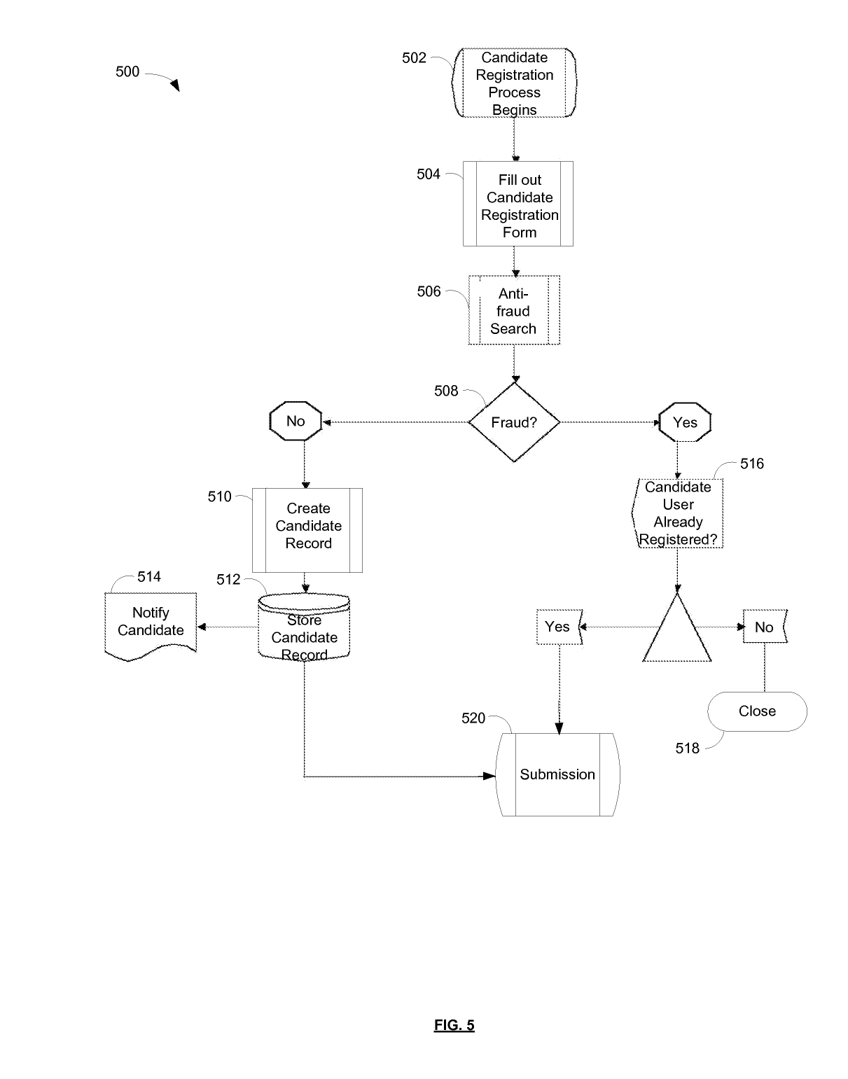

Database 102 of recruitment computing system 101 comprises at least one candidate record 220. Candidate records 220 will be discussed in further detail having regard to FIGS. 5 to 8.

Candidate record 220 may comprise at least one candidate submission 222. Candidate submission 222 may be created from input by a candidate user 111d on a user device 110. Candidate submission 222 pertains to an application on a job order 202. Candidate submissions 222 will be discussed in further detail having regard to FIG. 21.

Candidate record 220 may comprise at least one interview schedule 224. Interview schedule 224 may be created from input by a candidate user 111d on a user device 110. Interview schedule 224 pertains to information about the interviewing of the candidate user 111d by at least one hiring company user 111a, 111e. Interview schedules 224 will be discussed in further detail having regard to FIGS. 25 and 26.

Candidate record 220 may comprise at least one job offer 226. Job offer 226 may be created from input by a hiring company user 111a, 111e on a user device 110. Job offer 226 pertains to information about a job offer made to candidate user 111d by at least one hiring company user 111a, 111e. Job offers 226 will be discussed in further detail having regard to FIG. 29.

In certain embodiments, recruitment system interface provides users 111 with pages with navigation and links to all information to which they have access.

Reference is now made to FIG. 2B, in which a method 249 for facilitating recruitment is illustrated. In an exemplary embodiment, processor 104 of recruitment computing system 101 of FIG. 1 performs method 249 for facilitating recruitment.

Processor 104 creates and stores in database 102 at least one hiring company record at 250. Processor 104 performs an anti-fraud search on the at least one hiring company record at 252. Hiring company record comprises at least one job order. Processor 104 creates and stores in database 102 at least one job order at 254. Processor 104 performs an anti-fraud search on the at least one job order at 256.

Processor 104 creates and stores in database 102 at least one recruiter record at 260. Processor 104 performs an anti-fraud search on the at least one recruiter record at 262. Processor 104 creates and stores in database 102 at least one candidate record initiated in the recruiter record at 264. Processor 104 performs an anti-fraud search on the at least one candidate record at 266.

Processor 104 creates and stores in database 102 at least one relationship record at 270.

Processor 104 creates and stores in database 102 at least one recruiter submission at 272. Processor 104 performs an anti-fraud search on the at least one recruiter submission at 274. Processor 104 creates and stores in database 102 at least one candidate submission initiated in the recruiter record at 276. Processor 104 performs an anti-fraud search on the at least one candidate submission at 278.

Processor 104 transmits the submission at 280 where processor 104 determines that there has been no fraud, the candidate submission corresponds to the recruiter submission, and an amount of recruiter submissions is less than or equal to an amount of hiring company specified submissions.

Processor 104 provides submission advancement at 282, including ranking the candidate record.

Processor 104 provides interview scheduling at 284, including creating an interview schedule from data in the hiring company record and the candidate record and transmitting the interview schedule.

Processor 104 provides job offer acceptance, rejection, and counter offer processing at 286, including creating an offer in the candidate record, wherein the creation of the offer is initiated in the hiring company record, and wherein after the offer is created the offer is accepted, rejected, or a counter-offer is created.

Processor 104 provides a billing process at 288.

While candidate users 111d, recruiter users 111b, 111c, and hiring company users 111a, 111e are all users 111 of system 101 they each have separate registration issues.

Reference is now made to FIG. 3, in which a method 300 for creating a hiring company record is illustrated. The hiring company record created can be, for example, the hiring company record 200 illustrated in FIG. 2A. In one embodiment, hiring company record 200 comprises information entered and controlled by hiring company user 111a, 111e.

At 302 hiring company user 111a, 111e, using a user device 110, for example, begins the registration process. Hiring company user 111a, 111e, at 304 fills out fields in a registration form on the online recruitment system interface and the information input is stored in database 102. In one embodiment, hiring company user 111a, 111e signs a contract (by someone with the authority to sign such a contract), which stipulates that the hiring company will pay a fee to the company operating the system upon an accepted offer by a candidate submitted to them via the system 101. In one embodiment, the contract further comprises a guarantee and rules for such a guarantee.

One of the fields required to be filled out by the hiring company user 111a, 111e is the list of hiring company administrative users and non-administrative users. Administrative users are users 111 that are able to manage the access of the non-administrative users within the hiring company record 200.

Non-administrative users 111 are, for example, employees of the hiring company who are experts in the area in which they are seeking to hire a candidate. Non-administrative users 111, for example, are often asked to interview candidates and provide feedback to the system 101. In certain embodiments the hiring company administrative user 111 will find it important to limit access to certain candidate information and feedback from non-administrative users 111. Limiting access to information in this way will prevent certain information from becoming public information or becoming available to other employees of the hiring company. This may avoid internal conflicts with existing and new employees.

Administrative and non-administrative users 111 are labeled in the hiring company record 200. For example, an administrative user 111 could be a human resources manager or a hiring manager of the hiring company. For example, non-administrative users 111 could be employees of the hiring company who only have interaction with a candidate during the interview process at an interview that they conduct.

Once hiring company user 111 has entered all the required information, processor 104 performs an anti-fraud search at 306. In one embodiment, anti-fraud search 306 is an operation performed by processor 104 that searches all hiring company records 200 within database 102 to see if the hiring company has already been registered. In one embodiment, this search 306 prevents abuse of the system 101. Specifically, the anti-fraud search 306 may prevent non-payment of a placement fee or an attempt to create a new user to avoid penalties incurred by earlier misuse of the system 101.

At 308, processor 104 determines if there is fraud. In one embodiment, processor 104 is able to determine if there is a problem with the hiring company user registration if there is a match in any critical information categories. If processor 104 determines that there is potential fraud then a conflict is created by processor 104 at 314, and stored in database 102 at 316.

In one embodiment, hiring company user 111a is prompted by processor 104 to contact a customer service representative of managing company 108 if a conflict is created. The conflict is handled in accordance with a conflict resolution system. Where fraud is determined at 308, hiring company user 111a will be denied access to system 101 by processor 104.

If no potential for fraud is determined at 308, processor 104 will create a hiring company record 200 at 310 and store hiring company record 200 in database 102. In one embodiment, at 312 hiring company user 111a will be sent a terms and conditions contract to be executed and returned by the hiring company user 111a. In a further embodiment, processor 104 performs a standard credit check on hiring company user 111a. Once the hiring company user registration process is completed successfully, hiring company user 111a will have access to their hiring company record 200.

New hiring company users 111a for a particular hiring company may be added at any time. In one embodiment, the new hiring company user 111a will undergo anti-fraud search 306 to avoid duplicate files and fraud.

Reference is now made to FIG. 4, in which a method 400 for creating a recruiter record is illustrated. The recruiter record created can be, for example, the recruiter record 210 illustrated in FIG. 2A. In one embodiment, recruiter record 210 comprises information entered and controlled by recruiter user 111b, 111c.

At 402 a recruiter user 111b, using a user device 110, for example, begins the registration process. Recruiter user 111b, at 404 fills out fields in a registration form on the online recruitment system interface and the information input is stored in database 102.

Similar to anti-fraud search 306 for hiring company user 111a, processor 104 performs an anti-fraud search at 406. In one embodiment, anti-fraud search 406 is an operation performed by processor 104 that searches the existing files of all recruiter records 210 within database 102 to see if recruiter user 111b has already been registered. At 408, processor 104 determines if there is fraud. In one embodiment, processor 104 determines that there is a problem with the recruiter user registration if there is a match in any critical information categories.

If processor 104 determines that there is potential fraud then a conflict is created by processor 104, at 426 and stored in database 102 at 428.

In one embodiment, recruiter user 111b is prompted by processor 104 to contact a customer service representative of managing company 108 if a conflict is created. The conflict is handled in accordance with a conflict resolution system. Where fraud is determined at 408, recruiter user 111b is denied access to system 101 by processor 104.

If no potential for fraud is determined at 408, processor 104 will create recruiter record 210 at 410 and recruiter record 210 is stored in database 102. In one embodiment, at 412, a customer service representative of the managing company 108 will review the registration information and verify the information through traceable elements. In one embodiment a traceable element is, for example, a telephone number or a billing address. For example, a call is made by the customer service representative to recruiter user 111b confirming the information submitted.

Once the information entered by the recruiter user 111 has been verified as clear 420, the registration is allowed at 422. In one embodiment, at 422, recruiter user 111b is sent a terms and conditions contract to be executed and returned by recruiter user 111b. Once the recruiter user registration process is completed successfully, recruiter user 111b will have access to their recruiter record 210.

In one embodiment, the contract sent at 422 will contain terms and conditions that are consistent with traditional recruitment practice. For example, unethical behavior, such as, attempting to create a fake candidate, is correlated with specific consequences.

If there is an issue found 414 during the customer review 412, a conflict is created by processor 104 at 416, stored in database 102 at 418, and the conflict is handled in accordance with the conflict resolution system.

The verification process allows recruiter users 111b to be assured that no one is impersonating them. In addition, candidate users 111d and hiring company users 111a can verify that the recruiter user 111b they are working with is traceable.

In certain embodiments where recruiter user is recruiter company user 111c as illustrated in FIG. 1, recruiter company user 111c is registered in a similar manner as recruiter user 111b. Once recruiter company user 111c is verified, new recruiter users 111b can be added by recruiter company administrative users 111c without having a new terms and conditions contract signed as the recruiter company user 111c will assume the monitoring of the recruiter user 111b. There can be recruiting company administrative users 111c and recruiting company non-administrative users 111c set up in a similar manner as hiring company administrative users 111a and hiring company non-administrative users 111a discussed above.

Reference is now made to FIG. 5, in which a method 500 for creating a candidate record is illustrated. The candidate record created can be, for example, candidate record 220 illustrated in FIG. 2A. In one embodiment, candidate record 220 comprises information entered and controlled by candidate user 111d.

Within recruitment and hiring practices, there is an issue with multiple submissions of the same candidate to the same job order or hiring company. This can be the result of recruiters sending a submission to a company without the candidate's consent or this can be the result of candidates submitting themselves directly to the hiring company multiple times or providing multiple recruiters the right to represent them to the hiring same company (in an effort to improve their chances of being hired). All users 111 are concerned with multiple submissions. Traditional recruitment and hiring processes do little or nothing to systematically prevent such occurrences.

At 502 recruiter user 111b, using a user device 110, for example, begins the candidate registration process. Candidate users 111d must be registered on the system before they can be presented to a company through a submission to a job order. To register, all candidate users 111d must be registered by recruiter user 111b. Once registered, a candidate user 111d is free to work with any recruiter users 111b they choose, and deny permission to any recruiter users 111b they choose to reject. Candidate user 111d can only have one candidate record 220.

Recruiter user 111b, at 504, fills out fields in a registration form on the online recruitment system interface and the information input is stored in the database 102. To register candidate user 111d, the recruiter user 111b will access the system and complete a form called Candidate Registration—Recruiter User. For every relationship between recruiter user 111b and candidate user 111d there is a Candidate Information—Recruiter User form used for submissions 214, 222. In the case of a first submission and simultaneous registration, the Candidate Registration—Recruiter User form doubles.

In certain embodiments, the fields include questions which, to be filled out accurately, require recruiter user 111b to engage in a discussion with the candidate user 111d. For example, recruiter user 111b will discuss salary expectations with candidate user 111d.

When the form is completed, processor 104 will perform the anti-fraud search 506. Similar to the anti-fraud search 306 for a hiring company user 111a, the processor 104 performs an anti-fraud search at 506. In one embodiment, anti-fraud search 506 is an operation performed by processor 104 that searches the existing files of all candidate records 220 within the database 102 to see if the candidate user 111d has already been registered. For example, processor 104 will cross reference the information entered by recruiter user 111b against all other candidate registration information to find duplicate candidate users. In one embodiment, processor 104 will cross-reference the name, phone numbers, and postal codes entered. If a duplicate is found, the recruiter user 111b is notified of the existing registration and the recruiter user 111b may proceed to attach to the candidate record 220 in the Candidate Registration—Recruiter User form as their Candidate Information—Recruiter User form.

In one embodiment, user 111 is not aware that the anti-fraud search is conducted. In a further embodiment, the anti-fraud search is transparent to user 111.

In certain embodiments where a hiring company user 111a is conducting the registration of a new candidate user 111d, whom is not a current employee of the hiring company, the form is called Candidate Registration—Hiring Company User.

At 508 the processor 104 determines if there is fraud. If the processor 104 determines that there is a duplicate entry but candidate user 111d is not already registered candidate record 220 is closed at 518 by processor 104.

If no potential for fraud is determined or no other candidate records 220 are found at 508, processor 104 will create candidate record 220 at 510 and candidate record 220 is stored in database 102.

In one embodiment recruiter user 111b may optionally make a submission with candidate user 111d at 520. Submissions are covered in further detail with reference to FIGS. 19-21.

In one embodiment, candidate user 111d is sent a notification (e.g. an email) by processor 104. The email, for example, indicates to candidate user 111d that they have been registered by recruiter user 111b on system 101 managed by managing company 108.

In one embodiment, the email comprises a link allowing candidate user 111d to proceed directly to the recruitment system interface to complete the registration. In one embodiment, candidate user 111d is optionally provided with a complaint mechanism within the email. If the candidate user 111d triggers the complaint mechanism, a conflict is created by processor 104 and stored in database 102. If candidate user 111d does not respond to the email candidate user registration will end.

Through this process, candidate users 111d are aware of who is registering them on system 101 and can end the process if they do not wish to proceed. In one embodiment, although basic candidate user information is often found online on Internet job boards, recruiter user 111b will not be able to register candidate user 111d without the candidate user 111d participating in the candidate user registration process.

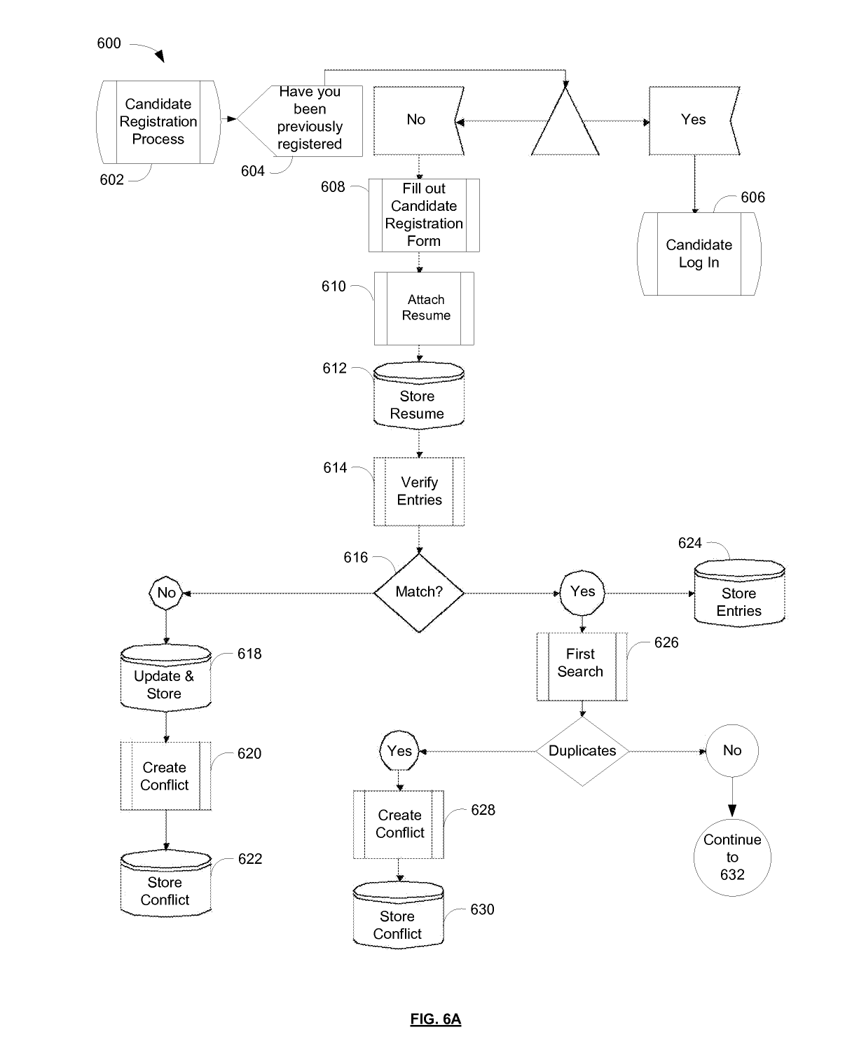

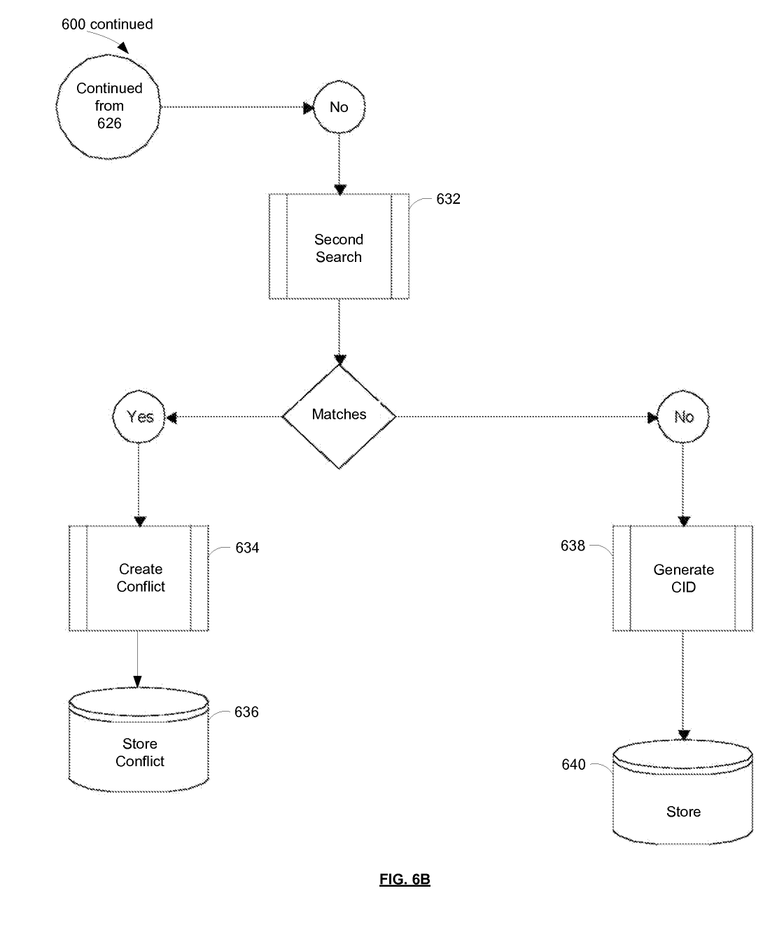

Reference is now made to FIGS. 6A and 6B, in which a method 600 for creating a candidate record is illustrated. The candidate record created can be, for example, the candidate record 220 illustrated in FIG. 5. At 602 a candidate user 111d, using a user device 110, for example, begins the registration process. Candidate user 111d engages the link that brings the candidate user 111d to the online recruitment system interface. At 604, candidate user 111d is asked if they have been previously registered. If candidate user 111d indicates using user device 110 that they have been previously registered, a user identification prompt and password prompt is presented at 606. This is asked of candidate user 111d as an additional guard to duplication, but more importantly as an overt act by candidate user 111d. In the event a conflict must be resolved at a later date, and recruiter user 111b claims candidate user 111d was the person falsifying their information, this overt act by candidate user 111d to indicate they have not yet been registered will help in any conflict resolution.

In one embodiment, where candidate user 111d indicates that they have never been registered before, the registration process continues to 608. The part of the registration performed by the candidate is called the Candidate Registration—Candidate User.

In one embodiment, candidate user 111d uploads a resume to candidate record 220 at 610. In a further embodiment, only candidate user 111d can upload a resume or make edits to the resume. In this embodiment, recruiter users 111b can not be blamed for modifying the candidate's resume. This is often a concern for hiring company users 111b and is often the policy of recruiting company user 111c. While recruiter user 111b can improve the format of a resume, hiring company users 111a prefer to see what kind of resume (e.g. document presentation skills) candidate users 111d create themselves. If recruiter user 111b makes an edit to the resume, candidate user 111d agrees with the edits and attaches the resume to candidate record 220. Candidate users 111d do not have to worry that their resume is changed by the recruiter user 111b. Hiring company users 111a know that recruiter user 111b has not adjusted the candidate's resume.

In one embodiment, recruiter user 111b accesses the resume in a view only mode, which does not allow for modification or editing of the resume stored in the candidate record 220. At 612, processor 104 stores the resume in database 102.

In one embodiment, at 614 the Candidate Registration—Recruiter User entries are not visible to candidate user 111d while candidate user 111d fills out the form. At 616, processor 104 compares the entries made to candidate record 220 by recruiter user 111b with the entries made to candidate record 220 by candidate user 111d.

Entries can be, for example, name, address, postal code, home phone, cell phone, work phone, current employer, university of undergraduate degree, and category title.

If all entries do not match, a conflict is created by processor 104 at 620 and stored in database 102 at 622. In one embodiment the candidate user registration is arrested at 618 until the conflict is resolved. If the conflict is a result of a mistake, candidate record 220 is amended by recruiter user 111b and candidate user 111d. If candidate user 111d is found attempting to create a duplicate candidate record, candidate record 220 is flagged. In one embodiment, all flagged candidate records 220 are collected by processor 104 and stored in database 102. This collection contains all of the information entered by candidate users 111d.

If all entries match at 616, then processor 104 stores the entries in database 102, at 624. At 626, processor 104 performs a first anti-fraud search 626. In certain embodiments, first anti-fraud search 626 comprises cross-referencing the entries with all other candidate user entries in the geographic region for duplicate files. For example, the entries that are cross-referenced could be information relating to a home phone number or a home address. In an embodiment, such a match may require a second anti-fraud search, as households may have multiple people in the house with identical addresses.

If there is an issue found during the first anti-fraud search 626, a conflict is created by processor 104 at 628, stored in database 102 at 630, and the conflict is handled in accordance with the conflict resolution system.

In one embodiment, if processor 104 identifies matched postal codes, processor 104 will then perform a second anti-fraud search 632. In certain embodiments second anti-fraud search 632 comprises checking the entries against all other candidate records 220 having the same postal code and all flagged candidate records 220.

For example, second anti-fraud search 632 will compare entries relating to a name, address, postal code, home phone, cell phone, work phone, current employer, university of undergraduate degree, category title, email address, and graduation date.

In certain embodiments entries are kept confidential. For example, graduation date is kept private on the system 101 and is used only for fraud prevention.

In further embodiments, any of the following may give rise to a finding of fraud: match of any phone number in a field other than the field list; match of (cell phone to cell phone) or (work phone to work phone); match of home phone & flagged; match of home phone & [(cell phone or work phone) or (university of undergraduate & graduation date & current employer)]; match address & flagged file; match address & [(cell phone or work phone) or (university of undergraduate & graduation date & current employer)]; match email=email; and match 5 of =[current employer, university of undergraduate, graduation date, category title, (last name or (last name=given name))].

In one embodiment, the anti-fraud searches are structured knowing that candidate users 111d can change their email address and the structure of their name, and candidate users 111d can not continuously find addresses or active phone numbers to use. As such, candidate user 111d may find a way to circumvent the first anti-fraud search but fraud is identified in a subsequent search. In a further embodiment, the entries are recorded in database 102 and are flagged for future reference during registration.

If there is an issue found during second anti-fraud search 632, a conflict is created by processor 104 at 634, stored in database 102 at 636, and the conflict is handled in accordance with the conflict resolution system.

If there is no issue found during second anti-fraud search 632, processor 104 generates a Candidate Identification Number (CID), at 638 and stores the CID in database 102 at 640.

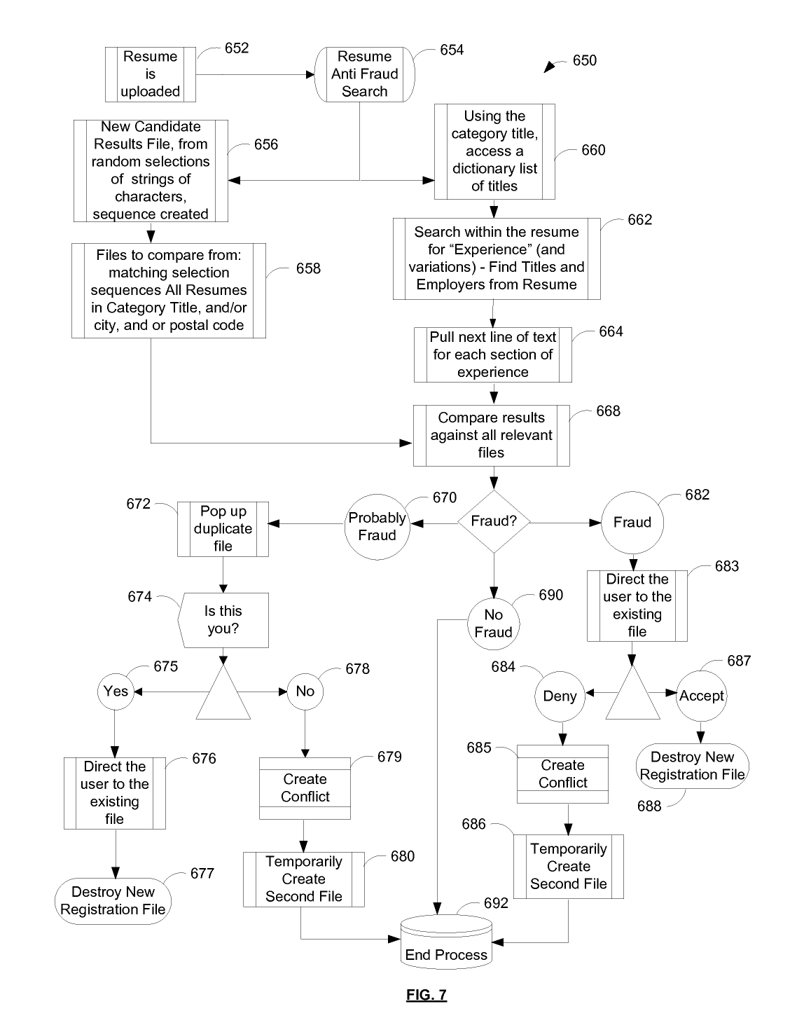

Reference is now made to FIG. 7, in which a method 650 for performing an anti-fraud search on candidate record 220 is illustrated. Method 650 begins, at 652, where a resume is uploaded to candidate record 220 as described, for example, at 610 of FIG. 6A. In an embodiment, processor 104 performs an anti-fraud search 654 on the uploaded resume.

In an embodiment, anti-fraud search 654 comprises searching within a resume by converting resumes into a common form. For example, at 656, processor 104 converts the resume file into text and searches for similar characters in a random selection of character strings to create a sequence. At 658, processor 104 uses the created sequence to search within resumes in existing candidate records 220 on database 102 to find common character strings or similar formatting. In a further embodiment, processor 104 selectively searches within resumes having common characteristics. For example, processor 102 only searches within resumes that originate from a specified geographical region (e.g. city, and/or postal code and/or URL). In certain embodiments, processor 102 searches within resumes having a certain category title for common character strings.

In an embodiment, anti-fraud search 654 comprises processor 104 using the category title to access a dictionary list of titles in database 102, at 660. Processor 104 searches within the resume, at 662, for information detailing work experience. Processor 104 compares the information pulled from the resume at 664 with the dictionary list of titles to determine if there is information detailing work experience that matches with a listed category title in an existing candidate record 220. At 668, processor 104 uses the results of the comparison and searching to determine if there is a potential for fraud.

In an embodiment, processor 104 determines that there is a potential for fraud where there is at least one match between the uploaded resume and an existing candidate record 220.

If processor 104 determines that there is a potential for fraud at 670, certain information pertaining to the existing candidate record 220 that created the possibility of fraud will be displayed at 672. Processor 104, at 674, will prompt candidate user 111d to indicate whether the matching candidate record 220 is their candidate record 220. If processor 104 receives input, at 675, from candidate user 111d indicating that candidate record 220 is theirs, processor 104 will direct candidate user 111d to the existing candidate record 220, at 676. Processor 104 will delete the new registration file from database 102 at 677.

If processor 104 receives input, at 678, from candidate user 111d indicating that matching candidate record 220 is not theirs, a conflict is created by processor 104 at 679, a duplicate file is stored in database 102 at 680, and the conflict is handled in accordance with the conflict resolution system.

In an embodiment, processor 104 determines that there is fraud where there is a full match between the uploaded resume and an existing candidate record 220.

If processor 104 determines that there is fraud at 682, processor 104 will direct candidate user 111d to existing candidate record 220, at 683. If candidate user 111d accepts that existing candidate record 220 is theirs, at 687, processor deletes the new registration file from database 102 at 688. If candidate user 111d denies that existing candidate record 220 is theirs, a conflict is created by processor 104 at 685, a duplicate file is stored in database 102 at 686, and the conflict is handled in accordance with the conflict resolution system.

In an embodiment, processor 104 determines that there is no fraud where there are no matches between the uploaded resume and an existing candidate record 220. If processor 104 determines that there is no fraud or potential for fraud at 690, method 650 ends at 692.

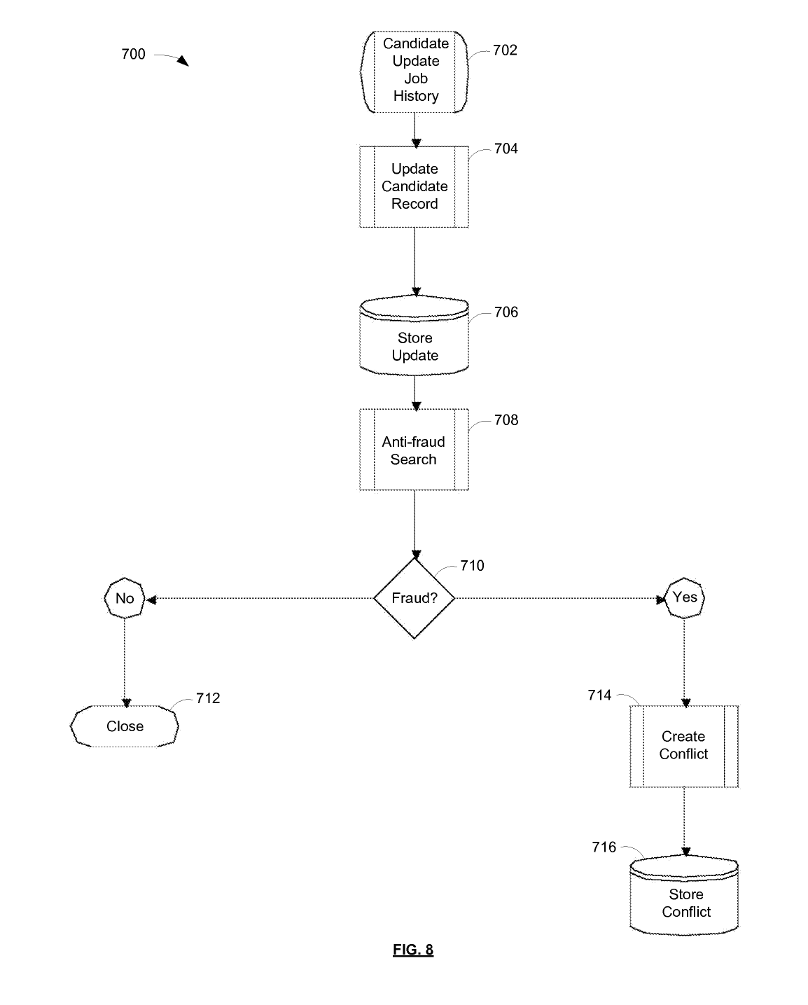

Reference is now made to FIG. 8, in which a method 700 for updating a candidate record 220 is illustrated. Method 700 begins at 702. Candidate user 111d will only ever have one candidate record 220 on the system 101, and will update 704 this candidate record 220 any time an adjustment is required. In certain embodiments, candidate user 111d will update the candidate record 220 in situations, such as, where there is a change in salary expectation or there are additions to the career history. For example, when candidate user 111d adds a new job to the career history, processor 104 stores the update in database 102. After the update, processor 104 conducts an anti-fraud search 710.

In one embodiment, anti-fraud search 708 comprises automatically searching database 102 for any submissions 214, 222 for that candidate user 111d and that hiring company user 111d. At 710, if such a submission 214, 222 is found, a conflict is created by processor 104 at 714, stored in database 102 at 716, and the conflict is handled in accordance with the conflict resolution system.

In one embodiment, if the conflict results in a finding that a hire was made in secret, processor 104 creates and sends an invoice to hiring company user 111a. Alternatively, if no fraud is found, the method 700 ends at 712.

Reference is now made to FIG. 9, in which a method 800 for creating a job order is illustrated. The job order created can be, for example, the job order 202 illustrated in FIG. 2A. In one embodiment, job order 202 is a request by hiring company user 111a to hire for a specific role. In another embodiment, job order 202 is not just for one person. For example, job order 202 is for a number of people, where each person is to be hired for the same role. In a further embodiment, the role has the same requirements, for example, the same job description. Job orders 202 may differ greatly from one role to the next, however in certain embodiments, all job orders 202 have the same structure.

At 802, hiring company user 111a begins the process of creating job order 202. Once hiring company user 111a creates job order 202, hiring company user 111a may hire another candidate that was not submitted by a recruiter user 111b if hiring company user 111a finds the other candidate on their own. In one embodiment, all hiring company candidates are submitted on system 101 in order to verify that hiring company user 111a made the hire on their own without a submission from recruiter user 111b and candidate users 111d are not submitted more than once.

In one embodiment, job order 202 comprises a job description. In a further embodiment, the job description does not constitute a complete job order 202.

Job order 202 accurately conveys to recruiter user 111b information about the position to be filled. In one embodiment this information includes, for example, what type of person the hiring company user 111a is looking for and in what timeframe the hire must be completed.

In one embodiment, job order 202 communicates to recruiter users 111b, 111c effectively to return candidate users 111d that are required and in the timeline required. In certain embodiments, job order 202 conveys a complete picture of the job, so that the candidate user 111d can evaluate their interest in the job. In a further embodiment, job order 202 is not manipulated as it passes from hiring company user 111a to recruiter user 111b to candidate user 111d.

In certain embodiments, job order 202 provides hiring company user 111a and recruiter user 111b all the answers to questions that recruiter user 111b needs to know with respect to the job. Hiring company user 111a answers those questions once via the job order 202 and any adjustments to the job order 202 are updated and communicated automatically by processor 104.

In certain embodiments, job order 202 comprises various fields. Some of the fields listed in job order 202 are made public to all users 111. Other fields may be kept private by hiring company user 111a. At 806 these fields are completed by hiring company user 111a using device 110, over network 105 on recruitment system interface. In one embodiment, the completed fields ensure hiring company user 111a is acting ethically and in accordance with the terms and conditions of the contract signed during registration. For example, hiring company user 111a will keep private information concerning the department the hired candidate would work in. While less information is provided to candidate users 111d and recruiter users 111b, telephone calls are prevented from being made directly to that department of the hiring company. Hiring company user 111a may express this information later in the process to candidate user 111d, for example during an interview. Hiring company user 111a has flexibility as to the types of job orders 202 created.

In certain embodiments, the fields comprise mandatory fields. Mandatory fields may comprise, for example “head count approval—Yes/No”. Hiring company users 111a post job orders 202 where the head count has not been approved, but recruiter user 111b and candidate user 111d are correctly informed. Recruiter user 111b and candidate user 111d can make an informed decision as to whether they wish to apply to and work at the job. In one embodiment, all mandatory fields comprise the basic amount of information required to constitute a functioning job order 202.

In certain embodiments, job order 202 comprise candidate ranking 208 criteria. Hiring company user 111a enters the criteria when creating job order 202. Candidate ranking criteria are not viewable by recruiter users 111b and candidate users 111d. When candidate user 111d and recruiter user 111b fill out a submission, they are entering values in a ranking criteria. Hiring company user 111a creates the ranking formula. Once candidate user 111d and recruiter user 111b have filled out a submission, processor 104 creates a ranking score for that candidate user 111d for that job order 202. Processor 104 is able to rank all submissions to job order 202 against each other. In certain embodiments, candidate rankings 208 are different for each job order 202.

At 804, the employee of the hiring company user 111a who creates job order 202 automatically has their name attached by processor 104 to job order 202 as the creator. In one embodiment this person is the hiring manager. In another embodiment, this person is not the hiring manager and there is a field to list the hiring manager. The creator of job order 202 is tagged by processor 104 and stored in database 102 to track and monitor use of system 101.

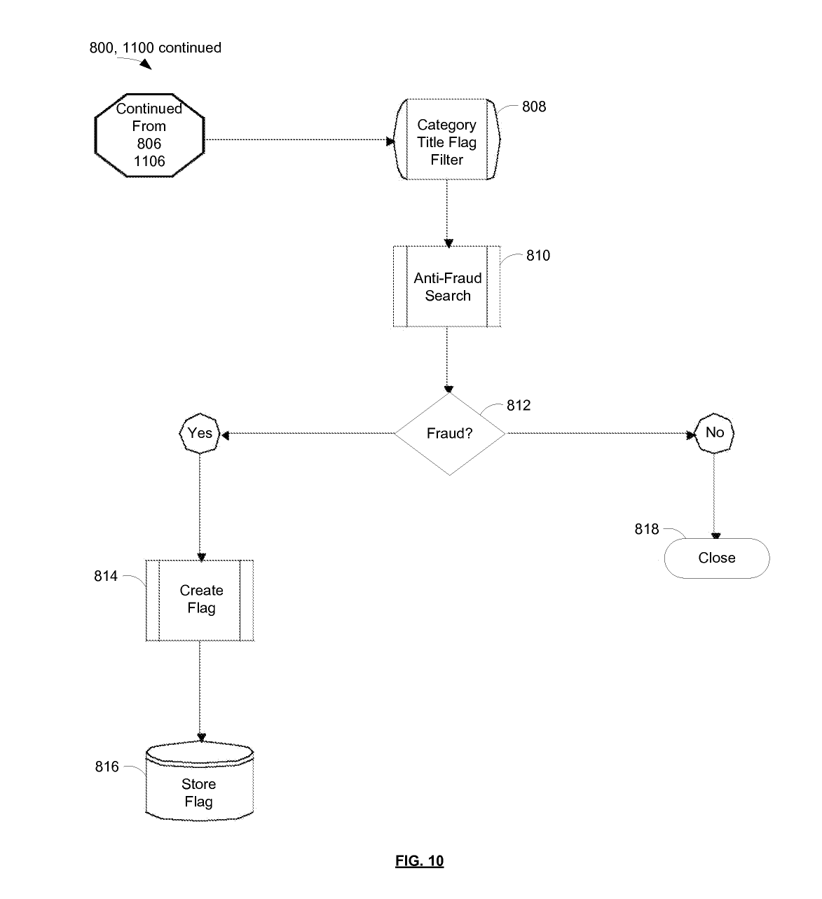

Reference is now made to FIG. 10, in which a method 800 for creating a job order is further illustrated. In one embodiment, job order 202 comprises a mandatory field called category title. Category titles comprise a standard definition for job names. User 111, at 808, initiates processor 104 to run the category title flag filter. The category title flag filter allows user 111 to look up the meaning of any category title and use this information to understand what type of job order 202 is being made. The category title flag filter requires user 111 that is creating job order 202 to select a category title. This allows effective communication of the job position via job order 202.

In one embodiment, processor 104 conducts an anti-fraud search 810. In a further embodiment, anti-fraud search 810 comprises a monitoring process. Processor 104, at 812 determines whether the number of openings entered by user 111 corresponds with numbers of openings usually made for the same category title. For example, if hiring company user 111a enters a category title equal to a marketing executive, hiring company user 111a is usually going to enter the number of openings as equal to one, as there will usually only be a need for one marketing executive. If hiring company user 111a enters a category title equal to a call centre agent and hiring company user 111a enters the number of openings as one, a flag will be created. This is because, traditionally hiring company users would set the number of openings to a value of greater than one for a job like call centre agent. At 814, processor 104 creates a flag and stores the flag, at 816 in database 102. If there is no flag, the process closes at 818.

In one embodiment, monitoring process 810 is performed transparently to users 111 during the creation of each category title. In one embodiment, the full list of category titles will be constantly updated as new types of jobs orders 202 are created.

Reference is again made to FIG. 9, in which a method 800 for creating job order 202 is illustrated. After fields are filled out in job order 202 by hiring company user 111a at 806, processor 104 stores the information in database 102 at 820.

In one embodiment, processor 104 conducts anti-fraud search 822. Fraud may be, for example, where: (1) hiring company users 111a hire candidate users 111d in secret after receiving their submissions 222 through system 101; (2) hiring company users 111a subsequently create a second job order 202 and hire candidate users 111d, as internal candidate users 111d that were submitted to a first job order 202; and (3) hiring company users 111a hire additional candidate users 111d in secret after having hired at least one candidate user 111d using system 101.

In certain embodiments, anti-fraud search 822 comprises automatically searching database 102 for similar job orders 202. In an embodiment, anti-fraud search 822 comprises searching database 102 for similar submissions 214, 222 to job order 202. For example, a similar submission 214, 222 to job order 202 is a submission 214, 222 where: (a) hiring company user 111a is the same, hiring company employee who is the creator of the job order is the same, and the category title is the same; and/or (b) the category title and hiring manager are the same; and/or (c) the hiring manager is the same and where three of four fields match for: location, hours of operation, travel %, contract or permanent.

In one embodiment, anti-fraud search 822 is able to determine fraud where a hiring company user reposts under a different hiring company name, for example, by using a subsidiary name. In certain embodiments, anti-fraud search 822 returns a number of false positives.

In one embodiment, anti-fraud search 822 further comprises a search performed by processor 104 that searches the current employer field in candidate record 220. In a further embodiment, anti-fraud search 822 is able to determine if hiring company user 111a hired a submitted candidate user 111d in secret. For example, processor 104 is operable to determine if the hire was made within the ownership period and outside of the system 101. If this is determined, processor 102 invoices hiring company 111a and notifies recruiter user 111b.

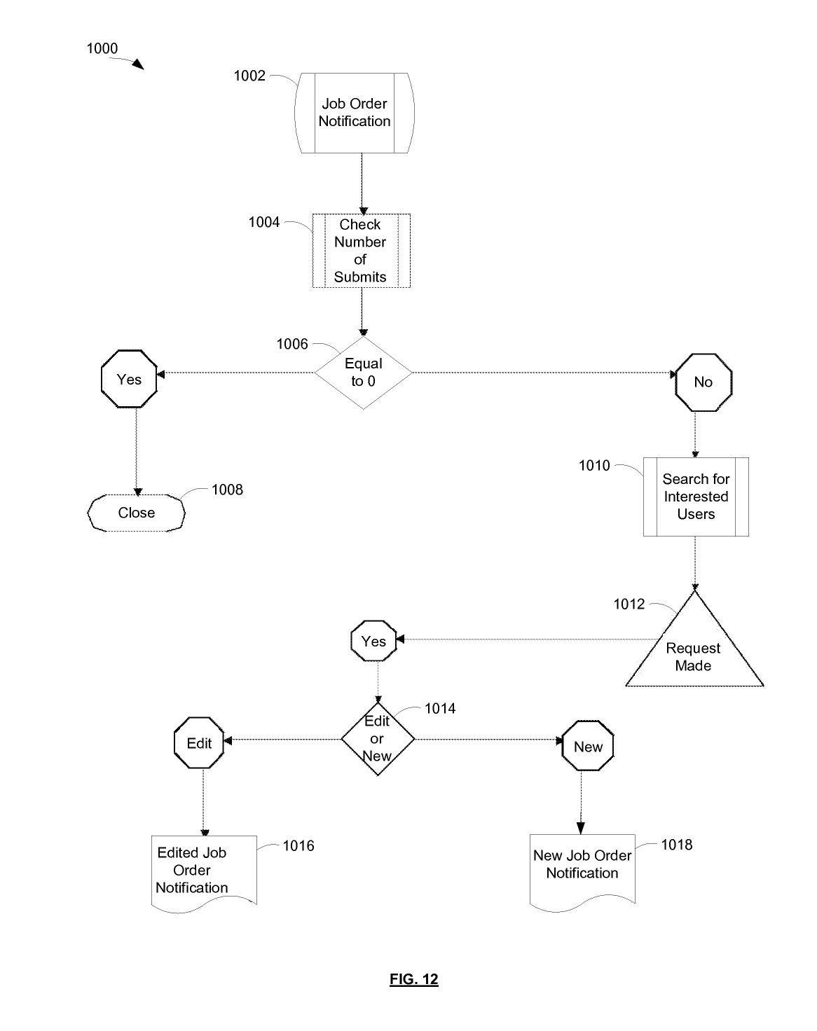

If no potential for fraud is determined by processor 104 during anti-fraud search 822, at 824, method 800 proceeds to 826 where job order notification emails are transmitted to users 111a interested in those job orders 202. Job order notification emails will be discussed in further detail having regard to FIG. 12.

If potential for fraud is determined, at 824, by processor 104 during anti-fraud search 822, method 800 proceeds to 828. At 828 processor 104 quires to hiring company user 111a whether a prior job order 202 is being edited. If hiring company user 111a indicates that a previous job order 202 is being edited, processor 104 stores the edits on database 102 at 830 and stores the edits on job order 202 at 832.

If hiring company user 111a indicates that a previous job order 202 is not being edited, processor 104 sends a job order warning (e.g. an email), at 834.

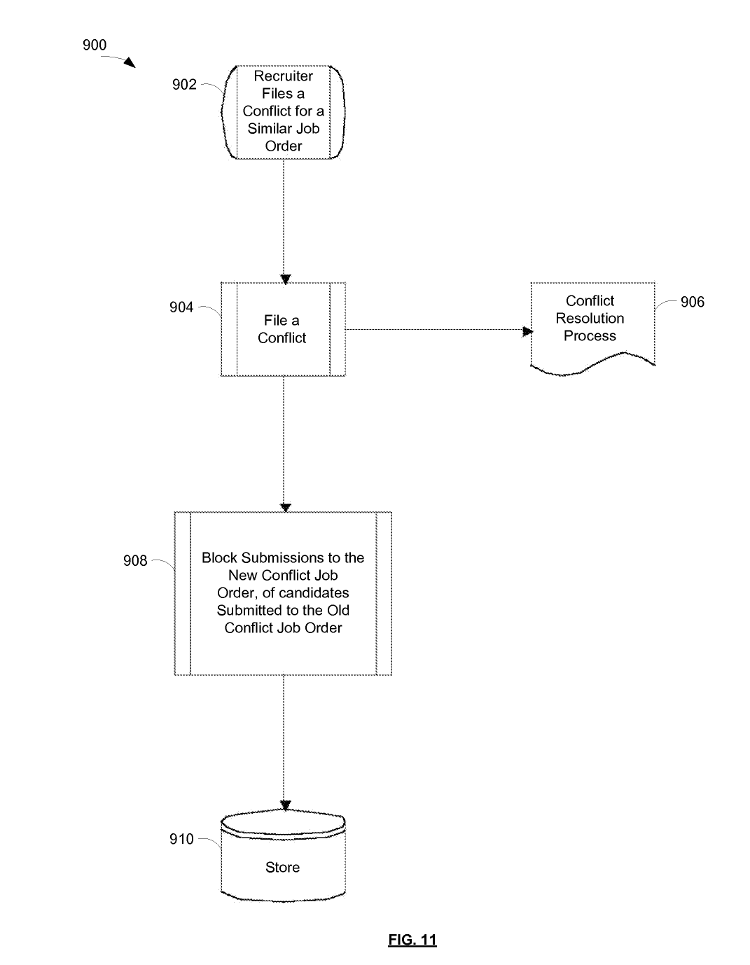

Reference is now made to FIG. 11, in which a method 900 for similar job order warning is illustrated. Recruiter user 111b is informed of the similar job order 202 via job order warning email, sent by processor 104 over network 106.

In one embodiment, the job order warning email is sent to recruiter users 111b with similar submissions 214 to job order 202 within a candidate ownership period. In one embodiment, the candidate ownership period is a set to an agreed upon time, for example, three to six months. The candidate ownership period is the time period where hiring company user 111a owes recruiter user 111b a placement fee if successful candidate user 111d is submitted by recruiter user 111b.

Recruiter user 111b reviews the similar job order 202. If recruiter user 111b believes that the similar job order 202 is an edited version of a job order that they had previously made a submission to, recruiter user 111b can initiate the creation of a conflict at 902. At 904 a conflict is created by processor 104, stored in database 102, and the conflict is handled in accordance with the conflict resolution system at 906.

In one embodiment, candidate user 111d will be temporarily blocked by processor 104 from making a submission 214, 222 to the similar job order 202, at 908. At 910, processor 104 stores the blocking on database 102. If the job order is determined to be similar, recruiter user 111b may optionally submit candidate user 111d to the similar job order 202.

If job order 202 is determined not to be similar during the conflict resolution process, processor 104 will unblock job order 202. If job order 202 is determined to be an edit of a previous job order 202 during the conflict resolution process, processor 104 will make adjustments to the previous job order 202 and inform hiring company user 111a of the change.

Reference is now made to FIG. 12, in which a method 1000 for notification of job orders is illustrated. When job orders 202 are created, processor 104 will begin the job order notification system at 1002. Processor 104 will check system 101 at 1004, and determine, at 1006 if hiring company user 111a that created job order 202 had a number of submits set to zero. If the number of submits is set to zero then no recruiter users 111b are notified and the process ends at 1008. If processor 104 determines that the number of submits is set to anything more then zero, the processor 104, at 1010, searches for all interested recruiter users 111b who have requested to be notified about certain job orders 202. At 1012, processor 104 reviews the requests from recruiter users 111b as to what types of job orders they will be notified about.

At 1014, processor 104 determines whether job order 202 is new or edited. At 1016, 1018 processor 102 sends recruiter users 111b an email from system 101 containing the details of job order 202. Where job order 202 is new, a new job order email is sent at 1018. Where job order 202 is edited, an edited job order email is sent at 1016.

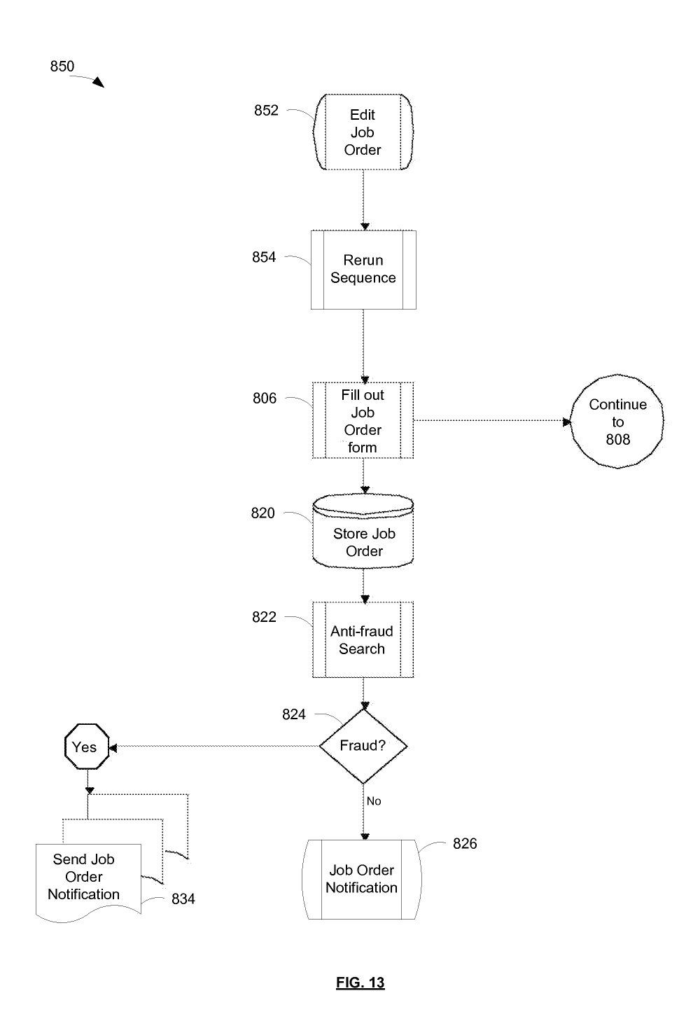

Reference is now made to FIG. 13, in which a method 850 for editing a job order is illustrated. Job orders 202 can change from the time they were originally created for a multitude of reasons. At 852 hiring company user 111a is provided with an option to edit job order 202. In one embodiment, processor 104, at 854, keeps all submissions 214, 222 and re-runs through all steps 800 of creating job order, as described with reference to FIGS. 9 and 10.

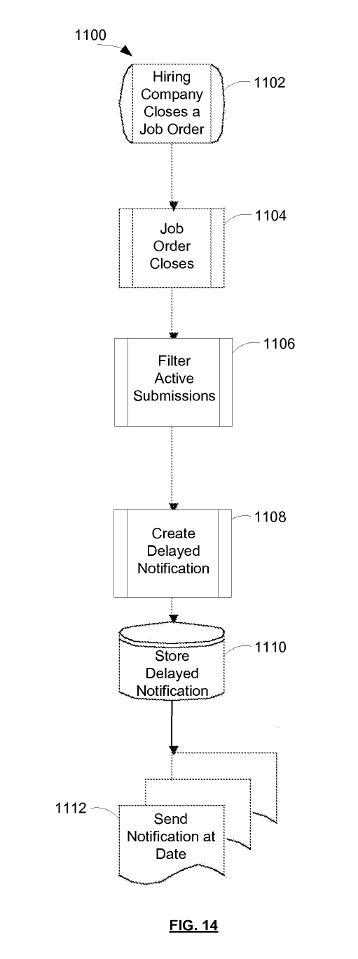

Reference is now made to FIG. 14, in which a method 1100 for monitoring job orders is illustrated. Where, hiring company user 111a posts job order 202 but does not hire any candidates, hiring company user 111a initiates the closing of job order 202 at 1102. Processor 104 closes job order 202, at 1104, and stores the closed job order 202 in database 102. At 1106, processor 104 identifies all recruiter users 111b who had an active submission 214 on that job order 202. At 1108, processor 104 creates a delayed email to those recruiter users 111b and at 1110 processor 104 stores the email in database 102. After a predetermined period of time, at 1112, processor 104 sends the email to recruiter users 111b reminding them to reconnect with candidate users 111d that were submitted on the closed job order 202. If recruiter user 111b finds that hiring company user 111a has committed a fraudulent hiring, recruiter user 111b may initiate the creation of a conflict.

In an embodiment, processor 104, after 1108, creates a calendar notice for a specified date and stores the calendar notice in database 102. Processor 104 will send the created email to recruiter user 111b on the date specified in the calendar notice.

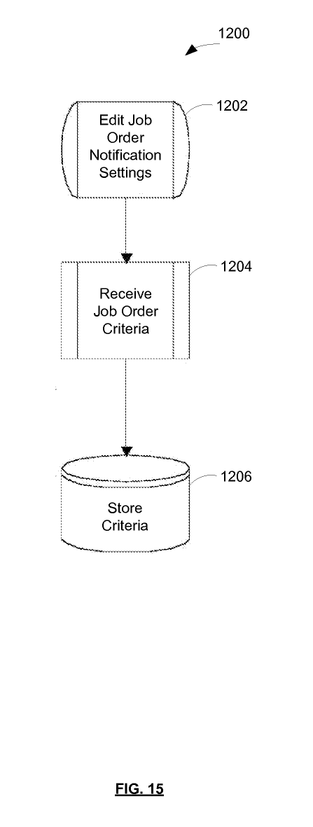

Reference is now made to FIG. 15, in which a method 1200 for editing job order notification settings is illustrated. At 1202, processor 104 receives criteria from user device 110, input by recruiter user 111b concerning types of job orders that recruiter user 111b is interested in receiving job order notification emails about. At 1204, processor 104 sets these criteria and, at 1206, stores the criteria in database 102.

In certain embodiments, recruiter users 111a are able to search system 101 for job orders 202 using search fields.

Reference is now made to FIGS. 16, 17, and 18 in which a method 1300 for managing a relationship record is illustrated. The relationship record managed can be, for example, relationship record 204, 216 illustrated in FIG. 2A. Relationship record 204, 216 allows hiring company user 111a to reward good recruitment work and punish bad recruitment work done by recruiter user 111b.

In one embodiment, hiring company 111a is able to add recruiter user 111b to a “My Recruiter” list on relationship record 204, 216. When hiring company user 111a adds, at 1301, recruiter user 111b to their “My Recruiter” list 1306 in relationship record 204, 216, the selected recruiter user 1304 is placed in an easy look up reference position within the hiring company record 200. This reference is saved in database 102, at 1308, and a notification email is sent to recruiter user 111b, at 1310. In one embodiment, for example, recruiter user 111b appears in a selectable list on the recruitment system interface.

This provides recruiter user 111b with an incentive to appear on many “My Recruiter” lists in relationship record 204, 216, as more attention may be given to their submissions and there may be an increased potential to make additional submissions.

If hiring company user 111a is impressed with submissions 214, 222 they received from recruiter user 111b, hiring company user 111a could reward recruiter user 111b with additional submissions 214, 222 to a job order 202. Conversely, if hiring company user 111a is not impressed with submissions 214, 222 they received from recruiter user 111b, hiring company user 111a could block recruiter user 111b from making submissions 214, 222 to a job order 202.

This also provides recruiter users 111b with an incentive to conduct themselves in the best possible manner within the system 101, for fear of being blocked by hiring company users 111a from job orders 202. These incentives encourage recruiter users 111b to provide a valuable service to hiring company users 111a. For example, recruiter user 111b may, when interviewing candidate users 111d, perform a necessary standard of due diligence for the recruitment process.

Once a recruiter user is on at least one “My Recruiter” list in relationship record 204, 216, hiring company user 111a can authorize them to make additional submissions 214, 222, at 1312. Processor 104 will receive this information from hiring company user 111a, at 1314. In one embodiment, at 1328, hiring company user 111a can give all recruiter users 111b, 111c on the list equal additional submissions 214, 222. In one embodiment, at 1316, hiring company user 111a can give individual recruiter users 111b additional submissions 214, 222. In a further embodiment, hiring company user 111a selects, via user device 110, whether the additional submissions 214, 222 are given for a particular job order 202 or generally, at 1318, 1330. Hiring company user 111a indicates the number of additional submissions 214, 222, at 1320, 1332. Processor 104 adds the additional submissions 214, 222 to relationship record 204, 216, at 1322, 1334. Additional submissions 214, 222 are saved in database 102 at 1324, 1336. A notification email of the additional submissions 214, 222 is sent to recruiter user 111b, at 1326, 1338.

In one embodiment, hiring company user 111a may initially set the number of submissions for all recruiter users 111b to zero, allowing for no submissions 214, 222.

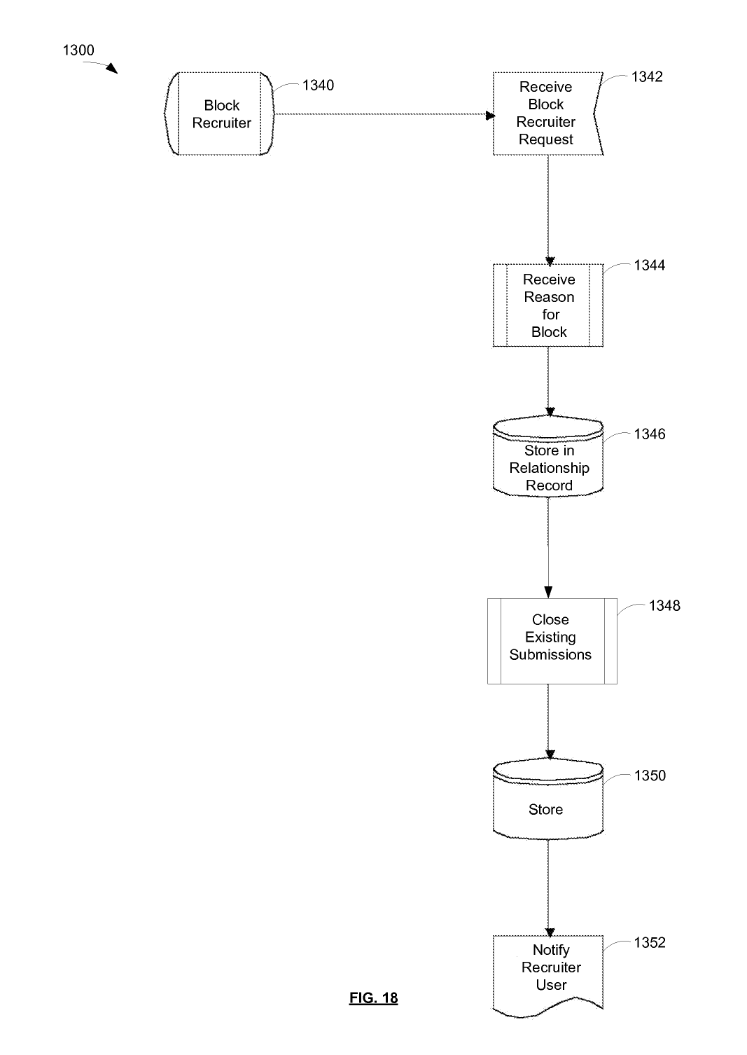

In one embodiment, hiring company user 111a may block at least one recruiter user 111b from making any submissions to job orders 202 made by that hiring company 111a, starting at 1340. As shown in FIG. 18 at 1342, processor 104 receives the request to block recruiter user 111b. Hiring company user 111a, at 1344, describes the reason for the block. Processor 104 closes any existing submissions 214, 222 made by the blocked recruiter user 111b, at 1348. Processor 104 stores the block in relationship record 204, 216, at 1250. Recruiter user 111b is sent a notification of the block at 1352. In one embodiment, recruiter user 111b may receive the reasons for the block. In certain embodiments, managing company 108 may overturn the block.

In one embodiment, hiring company users 111a can view and manage the relationship record 204, 216. Recruitment system interface has a relationship record page, where hiring company users 111a can view all the submissions made by all recruiter users 111b on the “My Recruiter” list or each specific recruiter user 111b.

Reference is now made to FIG. 19 in which a method 1400 for creating a submission is illustrated. The submission created can be, for example, submission 214, 222 illustrated in FIG. 2A. A submission is the complete application of candidate user 111d to job order 202, submitted by recruiter user 111b. A submission is comprised of: (1) the candidate resume, (2) candidate submission 222, (3) recruiter submission 214, and (4) a submission form.

Recruiter user 111b may submit candidate users 111d that they have registered, for example, as illustrated in FIG. 5. In certain embodiments, recruiter user 111b may submit candidate users 111d that were registered by another recruiter user 111b. If candidate user 111d has not yet been registered, they can be registered as illustrated in FIGS. 5 and 6. Candidate user 111d can not be submitted by a second recruiter user 111b on the same job order 202 or on a similar job order 202 at the same hiring company 111a.

Recruiter user 111b begins the submission process at 1402. Processor 104 receives input from recruiter user 111b, via user device 110, regarding what job order 202 the submission will be made to, at 1404. Processor 102 determines, at 1406, if recruiter user 111b has at least one available submission to this job order 202. If processor 104 determines that recruiter user 111b does not have any available submissions, the process ends at 1407. If processor 104 determines that recruiter user 111b has an available submission, processor 104 receives information from recruiter user 111b selecting candidate user 111d to be submitted at 1408. Processor 104 performs an anti-fraud search 1410. In certain embodiments, anti-fraud search 1410 comprises processor 104 searching database 102 for previous submissions. In certain embodiments, processor 104 determines that there is a potential for fraud where there is a matching previous submission.

If processor 104 determines at 1412 that there is a potential for fraud, processor 104 determines what type of submission is being made. If processor 104 determines that it is a recruiter user submission, at 1414, processor 104 indicates that a previous submission has been made, at 1416, notifies recruiter user 111b, and ends the process at 1418.

If processor 104 determines that it is a hiring company user submission, at 1420, processor 104 indicates that a previous submission has been made, at 1422, and transmits a notification of a flagged submission at 1424.

If processor 104 determines that a previous submission to job order 202 is not found, recruiter user completes the submission form, at 1426. In certain embodiments, where candidate user 111d has been registered, the candidate resume is automatically attached to the submission, at 1430. Where candidate user 111d has not yet been registered, the candidate resume is attached after registration. In certain embodiments, processor 104 sends notification to the candidate user 111d of the submission, at 1428. At 1432, processor 104 calculates the candidate user's ranking. At 1434, processor 104 labels the submission inactive and stores the submission in database 102.

In certain embodiments, the submission form comprises standard fields. In a further embodiment, processor 104, using information already found in recruiter record 210 and candidate record 220, automatically fills in some of the standard fields. For example, the “salary expectations” field is automatically filled on the submission form by taking the candidate user's field value for “salary expectations” from their candidate record 220. Accordingly, the “salary expectations” field will come directly from the candidate user 111d, via the candidate record 220, without any changes from recruiter user 111b.

In certain embodiments, the submission form comprises variable fields. Variable fields of the submission form come from responses to job order 202 information detailing required experience and skills. Recruiter users 111b or candidate users 111d will enter values in the variable fields in response to the listed experience and skills entered by the hiring company user 111a.

Reference is now made to FIG. 20 in which a method 1500 for managing permissions to represent is illustrated. The permission to represent managed can be, for example, permission to represent 212 illustrated in FIG. 2A. Permission to represent 212 is a declaration by candidate user 111d that they will work with recruiter user 111b to make a submission to job order 202.

After processor 104 notifies candidate user 111d, at 1428 of FIG. 19, that recruiter user 111b would like to submit candidate user 111d to job order 202, the submission is held as pending until recruiter user 111b is granted permission to represent 212 by candidate user 111d, via system 101. Permission to represent 212 does not extend to all submissions from the recruiter user 111b and only extends to that submission. Candidate user 111d must grant permission to represent 212 for each submission to every job order 202.

Recruiter users 111b are only granted permission to represent 212 candidate user 111d for that submission to that job order 202. If recruiter user 111b would like to submit candidate user 111d on another job order 202 another permission to represent 212 must be granted.

At 1502, candidate user 111d receives the notification sent at 1428 and candidate user 111d reviews the submission at 1504. Processor 104 determines whether the submission is being made by recruiter user 111b at 1508 or hiring company user 111e at 1506. If candidate user 111d indicates that they do not want to be submitted, candidate user 111d inputs this indication via user device 110, to system 101 at 1510. Processor 104 receives this indication and stores it at 1512 in database 102.

If candidate user 111d would like to proceed with submitting the submission, candidate user 111d grants permission to represent 212 at 1514. Processor 104, at 1516, creates permission to represent 212. At 1518, processor 104 determines if hiring company user 111a would like to receive notification of submissions from a previously indicated intention. If processor 104 determines, at 1520, that hiring company user 111a has indicated that they would like to receive notification, notification is sent to hiring company user 111a at 1524 and stored in database 102 at 1522. If processor 104 determines, at 1520, that hiring company user 111a has indicated that they would not like to receive notification, notification is not sent to hiring company user 111a and is stored in database 102 at 1522.

If candidate user 111d would like to proceed with the recruiter submission but does not agree with an entry in the submission form, candidate user 111d can edit the submission at 1526. Processor 104 receives the edits to the submission and stores them in database 102 at 1530. Processor 104 revokes a permission to submit at 1528 and creates a permission to represent 212 at 1532. Processor 104 notifies recruiter user 111b of the edit to the submission at 1534. Processor 104 stores the permission to represent 212 in database 102 at 1536. The submission is again held as pending, until a permission to submit is granted from recruiter user 111b.

Reference is now made to FIG. 21 in which a method 1600 for managing permissions to submit is illustrated. When recruiter user 111b begins the submission process, recruiter user 111b automatically grants permission to submit. When the submission form is edited by candidate user 111d, recruiter user 111b has no longer given their consent to the content of the submission.

At 1602, recruiter user 111b receives the notification sent at 1534 and recruiter user 111b reviews the submission at 1604. If recruiter user 111b indicates that they do not want to submit, recruiter user 111b inputs this indication via user device 110, to system 101 at 1606. Processor 104 receives this indication and stores it at 1608 in database 102.

If recruiter user 111b would like to proceed with submitting the submission, recruiter user 111b grants permission to submit at 1610. Processor 104, at 1612, creates permission to submit. At 1614, processor 104 determines if hiring company user 111a would like to receive notification of submissions from a previously indicated intention. If processor 104 determines, at 1616, that hiring company user 111a has indicated that they would like to receive notification, notification is sent to hiring company user 111a at 1620 and stored in database 102 at 1618. If processor 104 determines, at 1616, that hiring company user 111a has indicated that they would not like to receive notification, notification is not sent and is stored in database 102 at 1618.

If recruiter user 111b would like to proceed with the submission but does not agree with an entry in the submission form, recruiter user 111b can edit the submission at 1622. Processor 104 receives the edits to the submission and stores them in database 102 at 1626. Processor 104 revokes permission to represent 212 at 1624 and creates a permission to submit at 1628. Processor 104 notifies candidate user 111d of the edit to the submission at 1630. Processor 104 stores the permission to submit 212 in database 102 at 1632. The submission is again held as pending, until a permission to represent 212 is granted from candidate user 111d.

Through this process, all submissions are “signed off” by both recruiter user 111b and candidate user 111d indicating to hiring company user 111a that recruiter user 111b has a relationship with candidate user 111d and any submissions accurately reflect candidate user's desire to apply.

In certain embodiments, candidate user 111d can find a recruiter user 111b that agrees to their submission entries.

In one embodiment, if candidate user 111d attempts to circumvent system 101 by not applying through recruiter user 111b, system 101 will identify the potential for fraud as hiring company user 111a will have to submit their internal candidates through the system 101 and processor 104 will identify the duplicate candidate user or submission via the anti-fraud searches.

In one embodiment, timelines and relationships are established between recruiter users 111b, candidate users 111d, and hiring company users 111a and stored by processor 104 in database 102. In a further embodiment, these timelines and relationships are used by processor 104 to determine fraud.

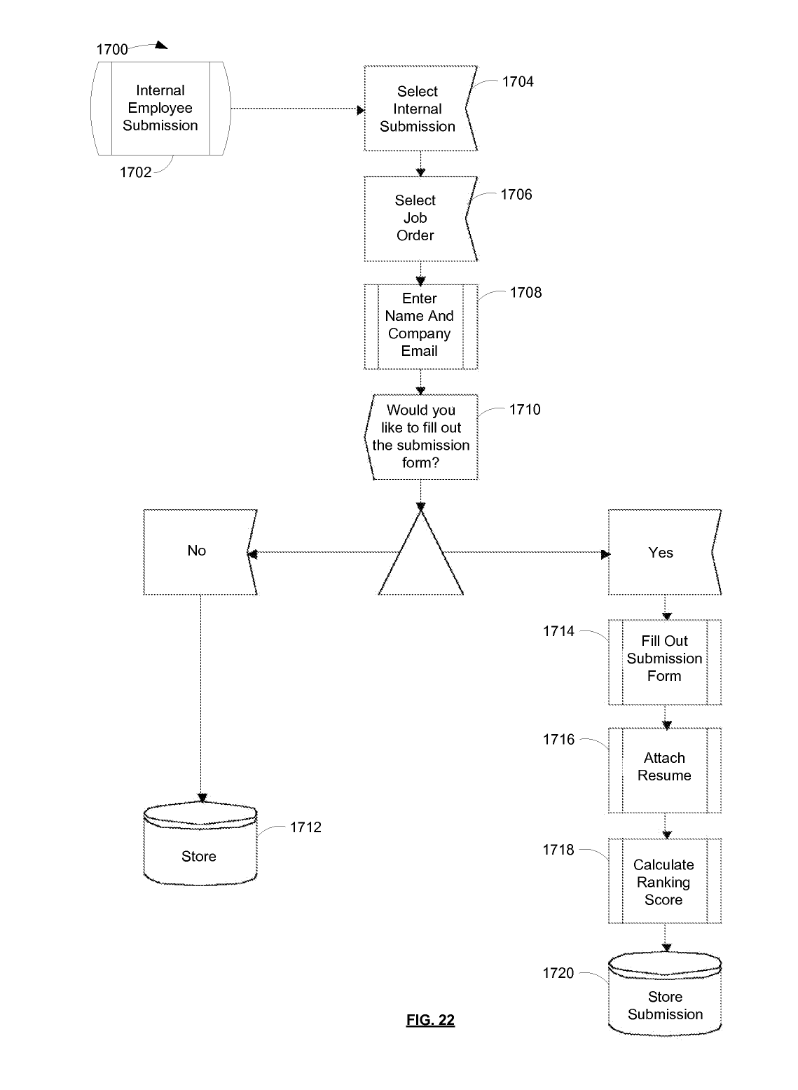

Reference is now made to FIG. 22 in which a method 1700 for creating an internal employee submission is illustrated. Hiring company user 111e begins the internal employee submission process at 1702 by selecting internal employee submission on the recruitment system interface at 1704. Processor 104 receives input from hiring company user 111e on to which job order 202 the submission is being made, at 1706, and the name and information of candidate user 111d being submitted at 1708. Processor 104 determines whether hiring company user 111e would like to fill out the submission form at 1710 from input made on user device 110 by hiring company user 111e. If processor 104 determines that hiring company user 111e does not want to fill out the submission form, processor 104 stores the submission information in database 102, at 1712, and ends the process.

If processor 104 determines that hiring company user 111e does want to fill out the submission form, hiring company user 111e fills out the submission form, at 1714. Processor 104, at 1716, automatically attaches the candidate resume, where candidate user 111d has been registered. Where candidate user 111d has not yet been registered, the candidate resume is attached after registration. At 1718, processor 104 calculates the candidate user's ranking. At 1720, processor 104 stores the submission in database 102.

In one embodiment, where hiring company user 111e creates the submission candidate user 111d does not have the ability to edit the submission. Candidate user 111d can accept the submission or choose not to apply to job order 202.

In certain embodiments, hiring company user 111e will differentiate between internal and external candidate users 111d. Where hiring company user 111e is creating a submission for an internal employee, the candidate user's name and email are entered and protected from viewing by other users 111.

Optionally, hiring company user 111e may fill out candidate user's ranking. Where candidate user 111d is an internal employee, candidate user 111d does not provide permission to represent 212.

In one embodiment, where candidate user 111d has applied to hiring company user 111a generally and not with respect to a particular job order 202 and hiring company user 111a has not connected candidate user 111d to a particular job order 202, recruiter user 111b will be able to submit candidate user 111d.

In certain embodiments, hiring company user 111a may set up an online posting having a “one-click” button that automatically runs the hiring company submission process for that candidate user 111d.

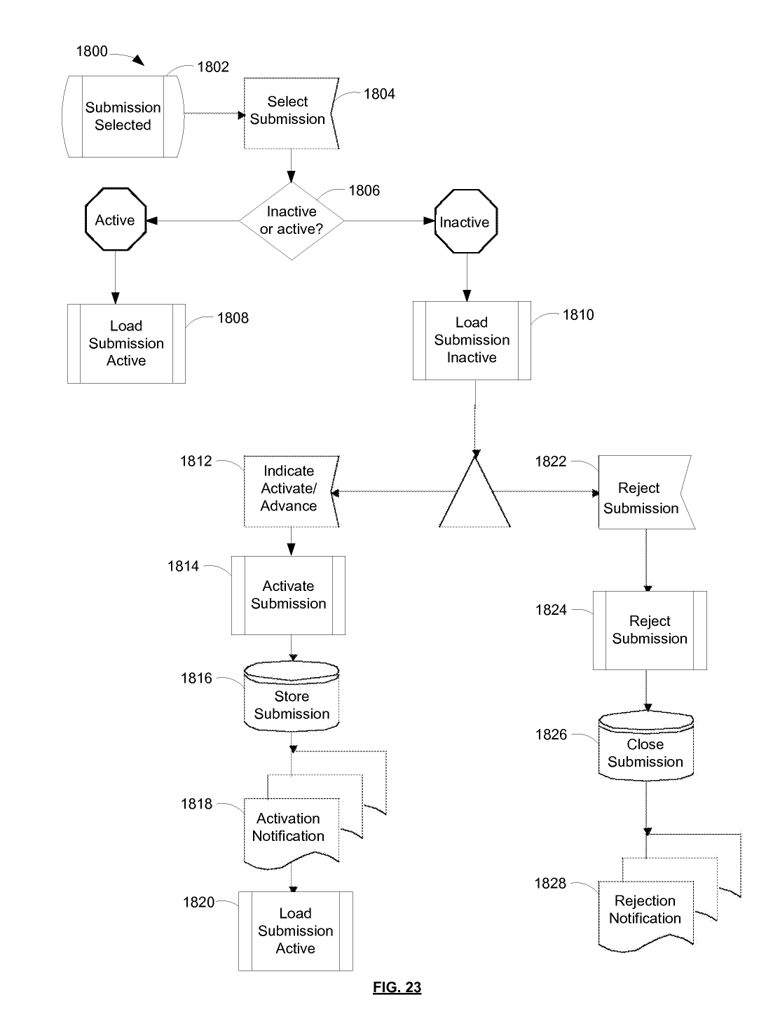

Reference is now made to FIG. 23 in which a method 1800 for activating a submission is illustrated. The submission created can be, for example, submission 214, 222 illustrated in FIG. 2A.

Once candidate user 111d has given their permission to represent 212 or recruiter user 111b has given their permission to submit, processor 104 transmits that submission is to hiring company user 111a. The transmitted submission is labeled inactive.

In one embodiment, where a submission is inactive, much of the candidate information is protected from viewing by hiring company user 111a by processor 104. For example, all contact information is hidden from hiring company user 111a. In certain embodiments, the difference between an active or inactive submission is the information that is blocked from viewing. Hiring company user 111a is able to review the candidate resume, the submission form as well as all other unblocked information.

In a further embodiment, there is sufficient information in an inactive submission for hiring company user 111a to make an early stage determination if the submission is worth further investigation. If so, hiring company user 111a can choose to activate the submission, thereby releasing additional information. Candidate user's direct contact information is still unavailable to hiring company user 111a. Hiring company user 111a is able to contact recruiter user 111b via interview scheduling 206, 224.

At 1802 hiring company user 111a inputs that they would like to review a submission and indicates what submission they would like to review at 1804. Processor 104 receives the request and determines at 1806 whether the selected submission is active or inactive. If processor 104 determines that the submission is active, processor 104, at 1808, loads the submission with the active information displayed. If processor 104 determines that the submission is inactive, processor 104, at 1810, loads the submission with the inactive information displayed.

Hiring company user 111a views the inactive information and decides whether to activate the submission. Hiring company user 111a determines if the submission appears likely to be a fit for job order 202. If hiring company user 111a determines that there may be a fit for job order 202, hiring company user 111a, at 1812, inputs direction to user device 110, and processor 104 activates the submission, at 1814, and stores the active submission in database 102, at 1816. At 1818, processor 102 sends notification to recruiter user 111b and candidate user 111d informing them that the submission is activated. At 1820, processor 104 loads the submission with the active information displayed.

If hiring company user 111a determines that there is not a fit for job order 202, hiring company user 111a, at 1822, inputs direction into user device 110, and processor 104 rejects the submission, at 1824, and closes the submission in database 102, at 1826. At 1828, processor 102 sends notification to recruiter user 111b and candidate user 111d informing them that the submission has been rejected and is closed.

In one embodiment, system 101 monitors the activity of hiring company user 111a. In a further embodiment, if hiring company user 111a is converting a large number of inactive submissions to active submissions without a corresponding number of scheduled interviews, processor 104 is able to determine that there is a potential for misuse of system 101. In certain embodiments, managing company 108 predetermines the number of activated submissions corresponding to the number of scheduled interviews. In a further embodiment, processor 104 informs managing company 108 of the potential misuse. In certain embodiments, system 101 is able to prevent hiring company user 111a from amassing a database of candidate users 111d and candidate resumes.

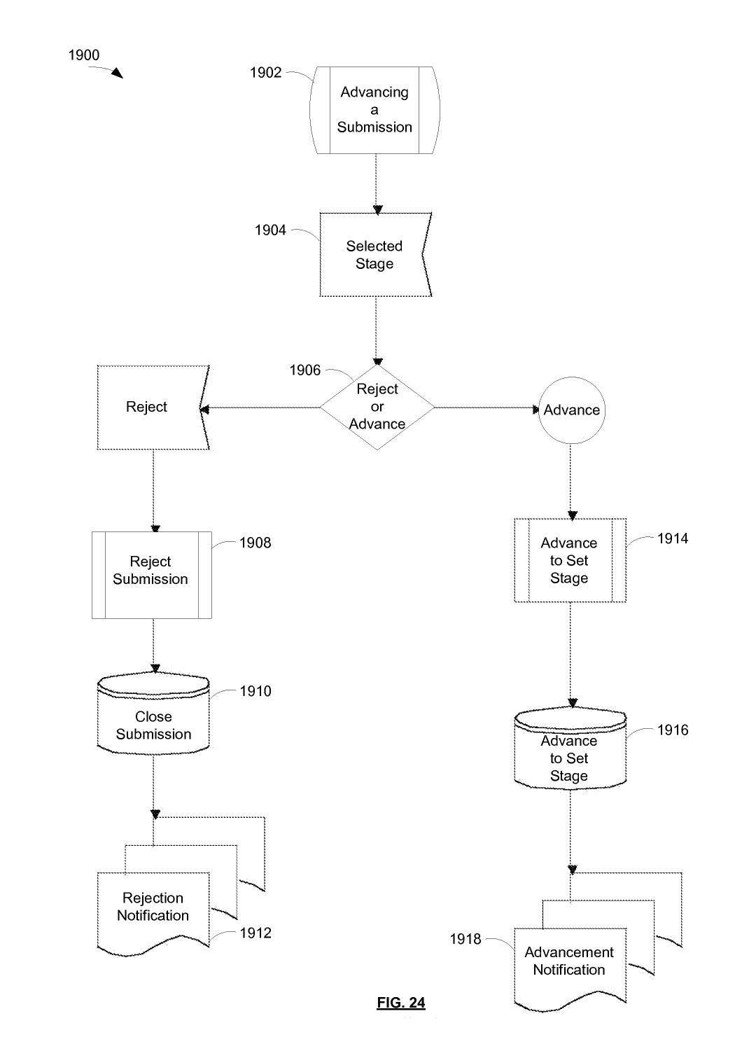

Reference is now made to FIG. 24 in which a method 1900 for advancing a submission is illustrated. The submission created can be, for example, submission 214, 222 illustrated in FIG. 2A. Where hiring company user 111a, after reviewing the active submission, is interested in advancing the submission, hiring company user 111a indicates their intent to advance the submission at 1902. Hiring company user 111a, at 1904, selects the stage, for example the interview stage, that they would like to advance the submission to. At 1906 processor 104 receives the selection. If the submission is rejected at 1908, processor 104 closes the submission at 1910, and sends notification to recruiter user 111b and candidate user 111d informing them that the submission is closed, at 1912. If the submission is advanced at 1914, processor 104 sets the stage to advance the submission to at 1916, and sends notification to recruiter user 111b and candidate user 111d informing them that the submission is advanced, at 1918.

In certain embodiments, hiring company user 111a can select the appropriate button and or link in the submission on the recruitment system interface. Hiring company user 111a is able to reject 1908 the submission at any time other than after an offer 209, 226 has been accepted.

Reference is now made to FIGS. 25 and 26 in which a method 2000 for scheduling an interview is illustrated. The interview schedule can be, for example, interview schedule 206, 224 illustrated in FIG. 2A. In certain embodiments, interview schedule is structurally identical throughout all stages of the hiring process. Interview schedule may comprise at least one of a date, a location, a phone number in the case of a phone interview, a list of attendees, and a declared structure.

Hiring company user 111a signifies their intent to interview, for example, by advancing a submission as at 1914. The advancement of a submission 1914 is a declaration by hiring company user 111 that this submission and candidate user 111d have been selected as one hiring company user 111a intends to interview. After determining to advance the submission, hiring company user 111a signifies their intent to coordinate an interview at 2002.

In certain embodiments, hiring company users 111a may select a button, icon, or link in the recruitment system interface to advance a submission 1914. In certain embodiments, hiring company user 111a may coordinate an interview at any time.

In an embodiment, hiring company user 111a is able to coordinate an interview directly with the candidate user 111d. Hiring company user 111a selects the job order at 2004, the candidate users 111d to be interviewed in that stage at 2006, at least one available time for each candidate user 111d at 2008, and at least one location for the interview at 2010 from a list of options provided by processor 104. Processor 104 stores this information in database 102 and creates a request for action at 2012. Processor 104 sends notification of the interview schedule and information to candidate user 111d to be interviewed at 2014.

Candidate user 111d accesses system 101 at 2016 and views the request for action at 2020 provided by processor 104 at 2018. Processor 104 presents the available times at 2022 and provides an available interview time option at 2024, a “no thank-you” option at 2038, or a request another time option at 2032. If candidate user 111d selects the “no thank-you” option, the process ends and no interview is scheduled. If candidate user 111d selects a request another time option at 2032, processor 104 creates a request for action at 2034 and notifies hiring company user 111a of the candidate user's 111d interest in scheduling another time. If candidate user 111d selects an available interview time at 2024, processor 104 removes that time from the list of available times at 2026 and creates a request for action at 2028 and notifies the interviewers at 2030.

Similarly, all stages of the interview process can be scheduled using such a method. In a further embodiment, for a second or subsequent interview, the telephone numbers of candidate users 111d can be released to the hiring company 111a, with the candidate user's 111d consent.

In certain embodiments, the request for action process is an automated solution for coordinating interviews and also is an improvement over traditional recruitment because it provides all the same features as traditional recruitment but also allows direct contact between candidate users 111d and hiring company users 111a.

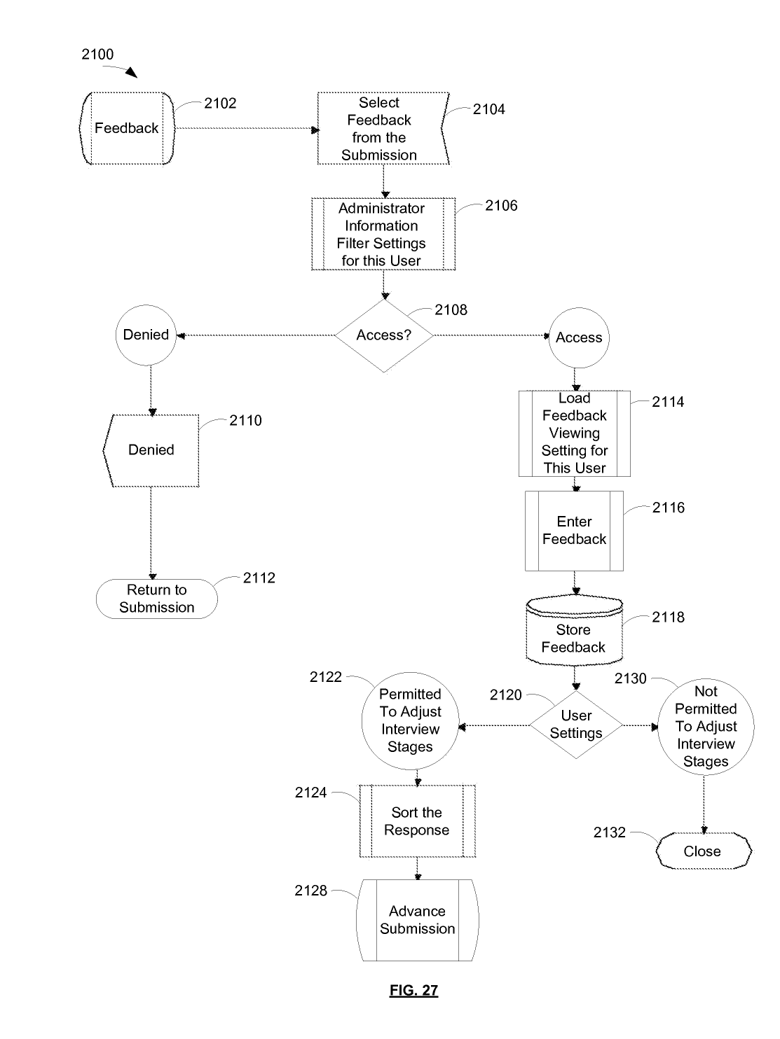

Reference is now made to FIG. 27 in which a method 2100 for creating feedback is illustrated. In certain embodiments, hiring company user 111a can create feedback for each stage of the interview process for use by hiring company user 111a. The interviewer, for hiring company user 111a, begins the process of giving feedback at 2102, after having interviewed candidate user 111d.

At 2104 hiring company user 111a selects the feedback selection in submission in the recruitment system interface. Processor 104 will determine, at 2108, if hiring company user 111a has access given by administrator user at 2106. If processor 104 determines that hiring company user 111a does not have access, access is denied at 2110, and processor 104 returns to the submission at 2112. In a further embodiment, administrator user 111 can remove or block information from access by an interviewer.

If processor 104 determines that hiring company user 111a does have access at 2108, processor 104 loads the feedback viewing settings for hiring company user 111a at 2114. Hiring company user 111a enters the feedback at 2116. Processor 104 stores the feedback in database 102 at 2118.

At 2120, processor 104 determines if hiring company user 111a is able to advance the submission. If not, at 2130, the process ends at 2132.

In certain embodiments, feedback comprises at least two elements: a field for written text, and a scroll down list that provides an action recommendation. An action recommendation may be, for example, reject, advance, or undecided. In one embodiment, the action recommendation is organized in system 101. If processor 104 determines if hiring company user 111a is able to advance the submission at 2122, processor 104 will sort the action recommendations at 2124 and advance the submissions at 2128.

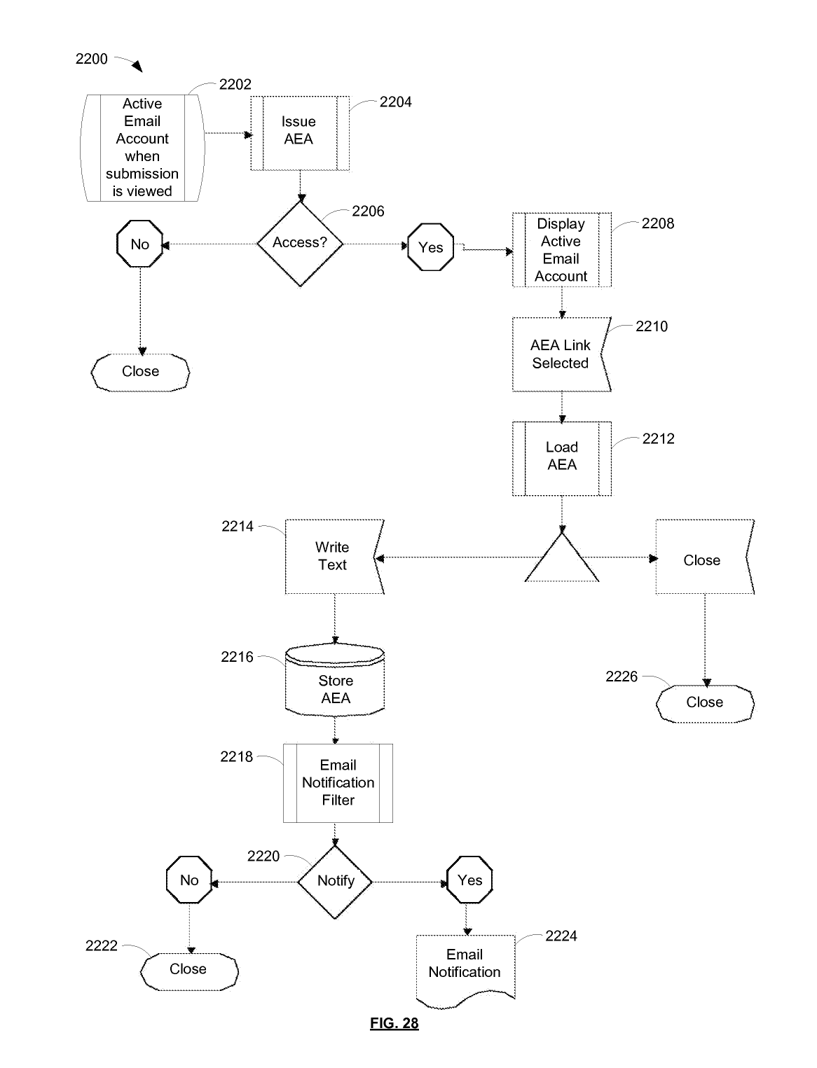

Reference is now made to FIG. 28 in which a method 2200 for managing active email accounts is illustrated. Active email accounts comprise a communication link between recruiter user 111b and hiring company user 111a for an active submission. In certain embodiments an active email account is specific to one submission. Processor 104 creates an option for the creation of an active email account when a submission is viewed by hiring company user 111a, at 2202. Hiring company administrative user 111a can issue active email accounts to users at any time before a first round or interviews.

In one embodiment, blocked recruiter users 111b can not have an active email account for hiring company user 111a that blocked them.

In a further embodiment, hiring company user 111a can give recruiter user 111a their direct contact information via the active email account.

Processor 104, at 2206, determines if user 111 has access to the active email account. If not, no active email account is displayed and the process ends. If processor 104 determines that user 111 has access to the active email account, processor 104 displays the active email account, at 2208. User 111 selects the active email account, at 2210, and processor 104 loads the active email account at 2212. User 111 may optionally, close the active email account, at 2226 or write text for a message, at 2214. Processor 104 stores the active email account message in database 102, at 2216 and sends notification of the active email account message, at 2218.

In one embodiment, at 2220 processor 104 determines if user 111 has previously indicated that they would like to receive notification. If yes, processor 104 sends the notification at 2224. If no, processor 104 does not send notification and the process ends at 2222.

Reference is now made to FIG. 29 in which a method 2300 for managing job offers is illustrated. The job offer can be, for example, job offer 209, 226 illustrated in FIG. 2A. In one embodiment, job offer is a legally binding offer to candidate user 111d from hiring company user 111a.

In one embodiment, job offer 209 comprises a compensation package. A compensation package may comprise, for example, a payment schedule, a start date, a probation term, a job description, vacation time and personal days, location, hours of operation, terms of employment (code of conduct, secrecy policy, etc). In certain embodiments, the terms of employment, location, payment schedule and job description are not negotiated by hiring company user 111a and candidate user 111d. In certain embodiments, the compensation package, start date, probation term, vacation time, personal days, hours of operation and expiration date of the job offer 209 are negotiated by hiring company user 111a and candidate user 111d.

In certain embodiments job offer 209 is presented by processor 104 on a non-printable page or a page that can not be copied to a word processing document. In certain embodiments candidate user 111d will read job offer 209 on user device 110.

At 2302, processor 104 creates job offer 209, from an intention made by hiring company user 111a and stores it in database 102. Processor 104 performs an anti-fraud search 2304 on the job offer 209. In certain embodiments, anti-fraud search 2304 comprises processor 104 searching system 101 for job offers made to the same candidate user 111d by the same hiring company user 111a. If another job offer 209 exists, in one embodiment, hiring company user 111a is prompted by processor 104 to answer: “an offer to CANDIDATE USER already exists. Are you attempting to edit this offer?” If hiring company user 111a answers no, a conflict is created by processor 104, stored in database 102, and the conflict is handled in accordance with the conflict resolution system. Alternatively, hiring company user 111a may chooses to edit the job offer 209.

In certain embodiments, anti-fraud search 2304 further comprises processor 104 searching for all other job offers 226 made to candidate user 111d during a certain time period and for all other job offers 209 made by hiring company user 111a during a certain time period. In certain embodiments the time period is one month. If processor 104 determines that another job offer 209 has been made to candidate user 111d, processor 104 will not transmit job offer 209 to candidate user 111d and hiring company user 111d is notified.

In certain embodiments, anti-fraud search 2304 further comprises processor 104 determining whether there are as many accepted job offers as there are positions available. When there are as many, processor 104 will not allow hiring company user 111e to make an offer to their own job order 209 until hiring company user 111e increases the number of positions available. In certain embodiments, processor 104 will allow hiring company user 111a to make many job offers 209, until there are as many accepted job offers as there are positions available.

In certain embodiments, anti-fraud search 2304 further comprises a search performed by processor 104 that searches hiring company records 200 over network 106. In certain embodiments, processor 104 searches the web pages of hiring company users 111b to find matches with hiring news. For example, anti-fraud search 2304 is conducted on career pages of hiring company users 111a and compares the listed on going hires on the career page with all records 200, 210, 220, in the system 101.

If anti-fraud search 2304 determines that there is no potential for fraud, processor 104 transmits the offer to candidate user 111d and recruiter user 111b, at 2306. Candidate user 111d, after receiving the notification of job offer 209, can accept job offer 209, reject job offer 209, or counter job offer 209. If candidate user 111d accepts job offer 209, processor 104 creates and stores the acceptance in database 102 at 2310. Processor 104 performs an anti-fraud search 2312 on accepted job offer 209. In certain embodiments, anti-fraud search 2312 comprises a similar search as in anti-fraud search 2304. Where no potential for fraud has been found, processor 104 sends notification of the acceptance to hiring company user 111a at 2314. In certain embodiments, candidate user's acceptance is legally binding.

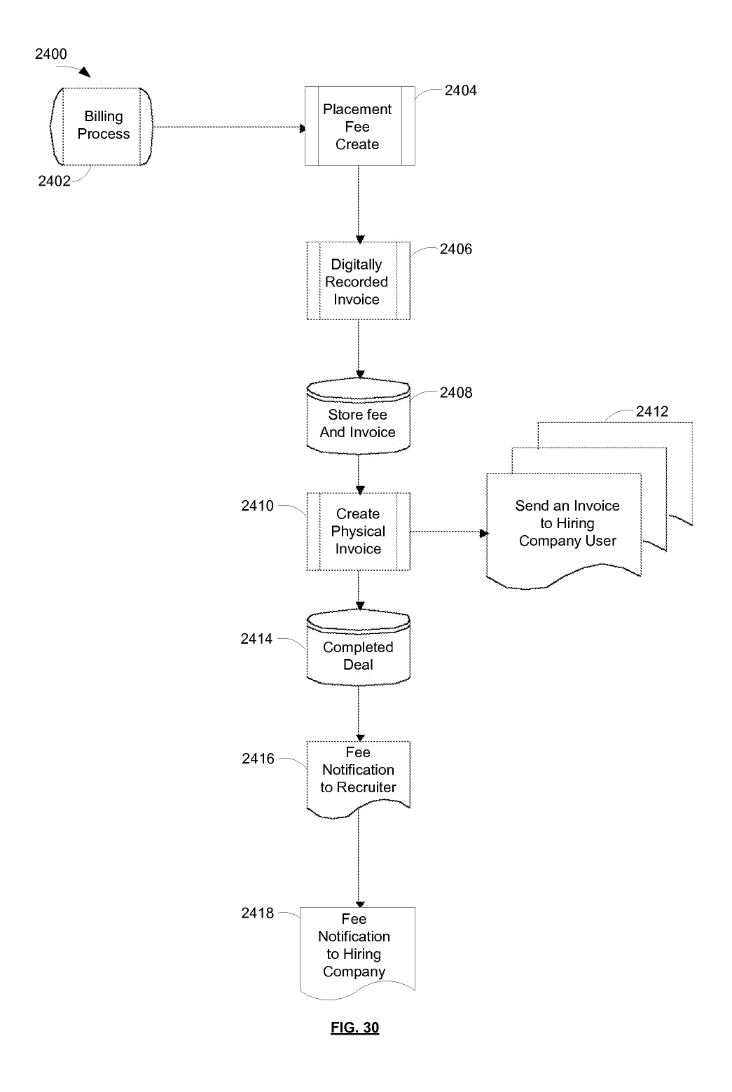

At 2316, processor 104 releases the contact information for candidate user 111d to hiring company user 111a and the contact information for hiring company user 111a to candidate user 111d. At 2318, processor 104 begins the billing process, as illustrated at FIG. 30.

If candidate user 111d rejects job offer 209, processor 104 creates and stores the rejection in database 102 at 2320. Processor 104 sends notification of the rejection to hiring company user 111a at 2322.

If candidate user 111d counters job offer 209, processor 104 creates and stores the counter-offer in database 102 at 2330. Processor 104 performs an anti-fraud search 2332 on the counter offer. In certain embodiments, anti-fraud search 2332 comprises a similar search as in anti-fraud search 2304. Where no potential for fraud has been found, processor 104 sends notification of the counter offer to hiring company user 111a at 2306. Hiring company user 111a can accept, reject, or counter the counter offer in a similar manner as candidate user 111d did with the initial job offer 209.

In certain embodiments, candidate user 111d may negotiate directly with hiring company user 111a, and hiring company user 111a may edit job offer 209 according to the agreed terms.

Reference is now made to FIG. 30 in which a method 2400 for managing billing is illustrated. Billing process is initiated at 2402 after the acceptance of job offer 209 by hiring company user 111a and candidate user 111d. Processor 104 creates the placement fee at 2404 and digitally records the invoice at 2406 where it is stored in database 102 at 2408.

Processor 104 creates a physical invoice at 2410. At 2412 processor 104 sends the invoice and a copy of the employment contract to hiring company user 111a. In certain embodiments, hiring company user 111a is to pay the fee before the previously agreed to guarantee time period.

Managing company 108 receives the payment from hiring company user 111a, holds the funds until the guarantee time period has expired and the deal is completed at 2414. Processor 104 sends notification of completed deal to hiring company user 111a at 2418.

Processor 104 sends notification of completed deal and the placement fee to recruiter user 111b at 2416. In certain embodiments, recruiter user 111b can monitor the status of the fee via recruitment system interface.

In certain embodiments, if candidate user 111d does not stay at the job until past the guarantee period, no payment is made.

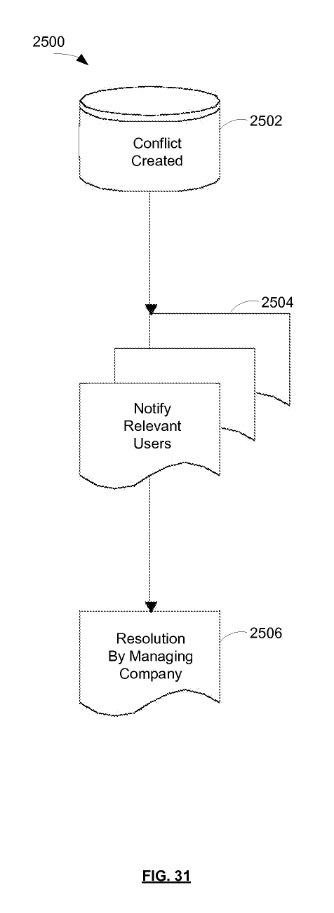

Reference is now made to FIG. 31 in which a method 2500 for managing conflict resolution is illustrated. Where processor 104 creates a conflict at 2502, relevant users are notified at 2504, and managing company 108 reviews and resolves the conflict at 2506.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto.

1. A system for facilitating recruitment, the system comprising:
a database for storing at least one hiring company record, at least one recruiter record, at least one candidate record, and at least one job order;
wherein creation of a candidate record is initiated in a recruiter record;
wherein a hiring company record comprises a job order and the job order conforms to a set of standard job order criteria;
wherein the hiring company record is controlled by a hiring company user, the recruiter record is controlled by a recruiter user, and the candidate record is controlled by a candidate user;
a processor coupled to the database, said processor operable to:
perform an anti-fraud search on the hiring company record, the recruiter record, the candidate record, and the job order;
wherein a candidate submission is initiated in the recruiter record;
wherein the candidate record comprises the candidate submission, and the recruiter record comprises a recruiter submission; and
transmit the candidate submission only where:
the anti-fraud search finds that there has been no fraud, and
the candidate submission corresponds to the recruiter submission, and
an amount of recruiter submissions is less than or equal to an amount of hiring company specified submissions.

2. The system of claim 1, wherein the anti-fraud search comprises comparing the hiring company record, the recruiter record, the candidate record, and the job order to an at least one corresponding prior hiring company record, recruiter record, candidate record, and job order.

3. The system of claim 2, wherein the processor is further operable to:
rank the candidate record, wherein the hiring company record provides input into a candidate record's ranking.

4. The system of claim 3, wherein the processor is further operable to:
create an interview schedule from data in the hiring company record and the candidate record and transmit the interview schedule.

5. The system of claim 4, wherein the processor is further operable to:
create an offer in the candidate record, wherein the creation of the offer is initiated in the hiring company record, and wherein after the offer is created the offer is accepted, rejected, or a counter-offer is created.

6. The system of claim 5, wherein the processor is further operable to facilitate a feedback module.

7. The system of claim 1, wherein the processor is further operable to create an at least one relationship record between the hiring company record and the recruiter record.

8. A method for facilitating recruitment, the method comprising:
storing at least one hiring company record, at least one recruiter record, at least one candidate record, and at least one job order in a database;
wherein creation of a candidate record is initiated by a recruiter record;
wherein a hiring company record comprises a job order and the job order conforms to a set of standard job order criteria;
performing an anti-fraud search on the hiring company record, the recruiter record, the candidate record, and the job order;
wherein a candidate submission is initiated in the recruiter record;
wherein the candidate record comprises the candidate submission, and the recruiter record comprises a recruiter submission;
wherein the hiring company record is controlled by a hiring company user, the recruiter record is controlled by a recruiter user, and the candidate record is controlled by a candidate user; and
transmitting the candidate submission only where:
the anti-fraud search finds that there has been no fraud, and
the candidate submission corresponds to the recruiter submission, and
an amount of recruiter submissions is less than or equal to an amount of hiring company specified submissions.

9. The method of claim 8, wherein the anti-fraud search comprises comparing the hiring company record, the recruiter record, the candidate record, and the job order to an at least one corresponding prior hiring company record, recruiter record, candidate record, and job order.

10. The method of claim 9, wherein the method further comprises:
ranking the candidate record, wherein the hiring company record provides input into a candidate record's ranking.

11. The method of claim 10, wherein the method further comprises:
creating an interview schedule from data in the hiring company record and the candidate record; and
transmitting the interview schedule.

12. The method of claim 11, wherein the method further comprises:
creating an offer in the candidate record, wherein the creation of the offer is initiated in the hiring company record, and wherein after the offer is created the offer is accepted, rejected, or a counter-offer is created.

13. The method of claim 12, wherein the method further comprises facilitating a feed back module.

14. The method of claim 8, wherein the method further comprises creating an at least one relationship record between the hiring company record and the recruiter record.

15. A non-transitory computer readable medium for performing the steps of the method of claim 8.
